(19) United States
(12) Patent Application Publication
(10) Pub. No.: US 2013/0347033 A1
(43) Pub. Date: Dec. 26, 2013

(54) METHODS AND SYSTEMS FOR USER-INDUCED CONTENT INSERTION

(71) Applicants: Eric W. Grab, San Diego, CA (US); William L. Thomas, Evergreen, CO (US)

(72) Inventors: Eric W. Grab, San Diego, CA (US); William L. Thomas, Evergreen, CO (US)

(73) Assignee: United Video Properties, Inc., Santa Clara, CA (US)

(21) Appl. No.: 13/530,775

(22) Filed: Jun. 22, 2012

(51) Int. Cl. H04N 21/254

(52) U.S. Cl. 725/34

(57) ABSTRACT

Methods and systems for presenting an advertisement are provided. A first user input selecting a past media event is received. An advertisement transmitted during the selected past media event is identified. A second user input specifying a circumstance under which the identified advertisement should be presented is received. When the circumstance specified by the second user input is met, a display of the identified advertisement is generated. Using the provided methods and systems, a user can select commercials that interest the user to replace default commercials transmitted during a program. A user can also replace default commercials with a display of the user's personal calendar, task list, or list of reminders.

### BACKGROUND OF THE INVENTION

Media consumers see many commercials while watching programs. However, not all commercials transmitted during a program are of interest to a user, perhaps because the user is not interested in the advertised products or services or because the user does not find the transmitted commercials entertaining. Other advertisements that were transmitted during a previous program may be stored in a database.

### SUMMARY OF THE INVENTION

Accordingly, systems and methods for presenting an advertisement in accordance with various embodiments of the present disclosure are provided. A user may desire to replace a default commercial during a program with another commercial that is more interesting to the user. The user may specify what kind of commercial should replace the default commercial, and which program's default commercial(s) should be replaced. At the appropriate time, a default commercial is replaced with a commercial that is more interesting to the user.

In some embodiments, a first user input is received that selects a past media event. In some embodiments, the selected past media event is a past live event. A first query for information corresponding to advertisements transmitted during the selected past media event may be transmitted to a server. From the server, data may be received that corresponds to an advertisement identified to have been transmitted during the selected past media event. A second user input may be received that specifies a circumstance under which the identified advertisement should be presented. A display of the identified advertisement is generated when the circumstance specified by the second user input is met. In some embodiments, the identified advertisement is inserted into a stream of video signals to be displayed on a user device.

In some embodiments, the specified circumstance is a commercial break in a currently viewed program. A commercial break is detected in the currently viewed program, and a currently transmitted commercial of the commercial break is replaced with the identified advertisement. In some embodiments, metadata of the replaced currently transmitted commercial are received. The metadata of the currently transmitted commercial are examined to determine the duration of the transmitted commercial. The identified advertisement has the same duration as the replaced currently transmitted commercial.

In some embodiments, a duration of the detected commercial break is calculated. From the server, information is received that corresponds to a plurality of advertisements identified as having been transmitted during the selected past media event and whose aggregate duration is equal to the calculated duration of the detected commercial break. A display of the identified plurality of advertisements is generated instead of currently transmitted commercials during the detected commercial break.

In some embodiments, a database of previously transmitted advertisements is stored on the server. Information tags corresponding to advertisements stored on the server are filtered for tags that match the selected past media event. In some embodiments, the tags may also be filtered based on a user profile. The received data includes information corresponding to a plurality of advertisements each having an information tag that matches the selected past media event. In some embodiments, a display is generated of representations of the plurality of advertisements having tags that match the selected past media event. A user selection of one of the displayed representations is received.

In some embodiments, a program guide database is accessed. A second query for past broadcasts of live events is transmitted to the program guide database. From the program guide database, a list of past live events that were broadcast in the past is received. A display of the list of past live events is generated. The selected past media event is a past live event selected from the generated display of the list of past live events.

In some embodiments, a display of selectable options for the circumstance under which the identified advertisement should be presented is generated. The options include: i) displaying the identified advertisement immediately, and ii) displaying the identified advertisement during a commercial break of a program.

In some embodiments, a display of a program guide is generated. A user selection is received of a program listing in the displayed program guide. The specified circumstance of the received second user input is a commercial break of a scheduled program corresponding to the selected program listing. A program guide database is accessed to determine a time period during which the scheduled program corresponding to the selected program listing will be transmitted. The display of the identified advertisement is generated when a commercial break is detected during the determined time period.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIGS. 1 and 2 show illustrative display screens that may be used to provide media guidance data in accordance with some embodiments of the disclosure;

FIG. 3 shows a block diagram of an illustrative user equipment device in accordance with some embodiments of the disclosure;

FIG. 4 is a diagram of an illustrative cross-platform interactive media system in accordance with some embodiments of the disclosure;

FIG. 5 shows an illustrative display screen of options for a past live event in accordance with some embodiments of the disclosure;

FIG. 6A shows an illustrative display screen of options for past advertisements in accordance with some embodiments of the disclosure;

FIG. 6B shows an illustrative display screen of options for displaying content in accordance with some embodiments of the disclosure;

FIG. 6C shows an illustrative display screen of options for when to display reminders in accordance with some embodiments of the disclosure;

FIG. 7 shows an illustrative display screen of options for when to insert selected content in accordance with some embodiments of the disclosure;

FIG. 8 shows an illustrative display screen of a calendar in accordance with some embodiments of the disclosure;

FIG. 9A shows an illustrative data structure for storing information about advertisements in accordance with some embodiments of the disclosure;

FIG. 9B shows an illustrative advertisement information data structure in accordance with some embodiments of the disclosure;

FIGS. 10A and 10B show illustrative schematics of inserting content into a stream of video signals in accordance with some embodiments of the disclosure;

FIG. 11 is an illustrative flow diagram for presenting an advertisement in accordance with some embodiments of the disclosure;

FIG. 12A is an illustrative flow diagram for searching a program guide database for past live events in accordance with some embodiments of the disclosure;

FIG. 12B is an illustrative flow diagram for searching a program guide database for past live events in accordance with some embodiments of the disclosure;

FIG. 13A is an illustrative flow diagram for searching an advertisement database for advertisements from a past live event in accordance with some embodiments of the disclosure;

FIG. 13B is an illustrative flow diagram for searching an advertisement database for advertisements from a past live event in accordance with some embodiments of the disclosure;

FIG. 14 is an illustrative flow diagram for displaying selected content during a selected program in accordance with some embodiments of the disclosure;

FIG. 15A is an illustrative flow diagram for replacing all default commercials of a commercial break with past advertisements in accordance with some embodiments of the disclosure; and

FIG. 15B is an illustrative flow diagram for displaying reminders during a commercial break in accordance with some embodiments of the disclosure.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above; for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices which they traditionally did not use. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more other types of user equipment devices, or for content available both through a television and one or more other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

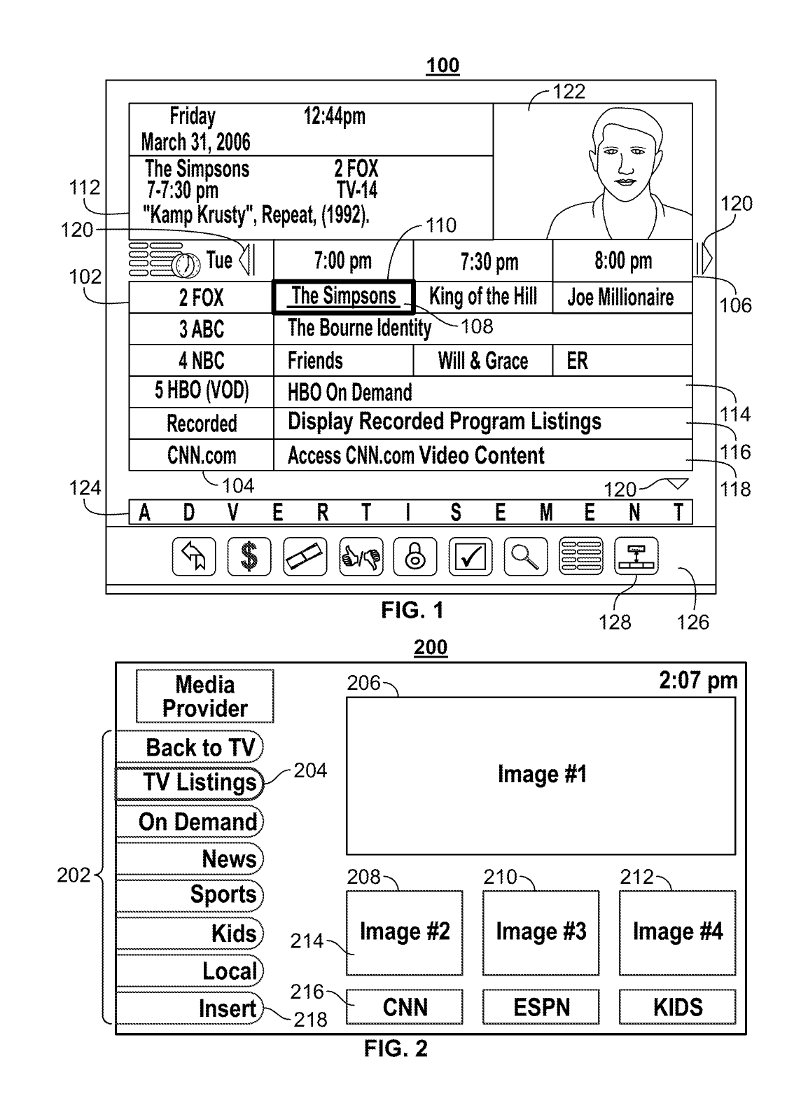

FIGS. 1-2 show illustrative display screens that may be used to provide media guidance data. The display screens shown in FIGS. 1-2 and 5-8 may be implemented on any suitable user equipment device or platform. While the displays of FIGS. 1-2 and 5-8 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase “guidance application data” should be understood to mean data used in operating the guidance application, such as program information, guidance application settings, user preferences, or user profile information.

In some embodiments, a user may indicate a desire to insert content into a stream of video signals by selecting a selectable option provided in a display screen (e.g., a menu option, menu tab, or icon) or pressing a dedicated button (e.g., an INSERT button) on a remote control or other user input interface or device. As referred to herein, the term “insert” or “insertion” used with respect to the term “content” should be understood to mean replacing content transmitted in a stream of signals, generating an instruction to display content specified by a user in an overlay that at least partially covers transmitted default content, or otherwise presenting to a user content that the user wants to view rather than content that is transmitted by default to the user. Inserted content may include an advertisement transmitted during a live event in the past, a user's personal calendar, a user's personal task list, or a user's list of reminders. As referred to herein, the term “live event” should be understood to mean an event that is broadcast, transmitted, streamed (e.g., over the Internet), or otherwise made available for viewing, while the event is occurring, to people not physically present at the event. While live events are used as illustrative examples in the subsequent figures, it should be understood that embodiments where live events are discussed are equally applicable to non-live events (e.g., television programs, on-demand programs, non-live pay-per-view programs).

In some embodiments, in response to a user input indicating a desire to insert content into a stream of video signals, control circuitry on a user equipment device may provide one or more display screens of options for what type of content to insert and when the content should be inserted into a stream of video signals. In some embodiments, the display screens of options may be provided by a media guidance application. In some embodiments, the user input indicating a desire to insert content into a stream of video signals may be received by control circuitry on a first user equipment device, and in response to receiving the user input, one or more display screens of options may be provided for display by control circuitry on a second user equipment device that acts as a second screen device. Using a second user equipment device, such as a mobile device, as a second screen device may allow the user to view a media guidance application display screen on the first user equipment device while viewing display screens of options for inserting content on the second screen device. As referred to herein, the term “mobile device” should be understood to mean any portable user equipment device, such as a laptop computer, a tablet computer, a hand-held computer, a personal digital assistant (PDA), a mobile telephone, a portable video player, a portable music player (e.g., iPod, MP3 player), a portable gaming machine, and a smart phone.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to on-demand programming (e.g., content accessible to a user equipment device at any time and is not provided according to a schedule). On-demand programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for on-demand programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

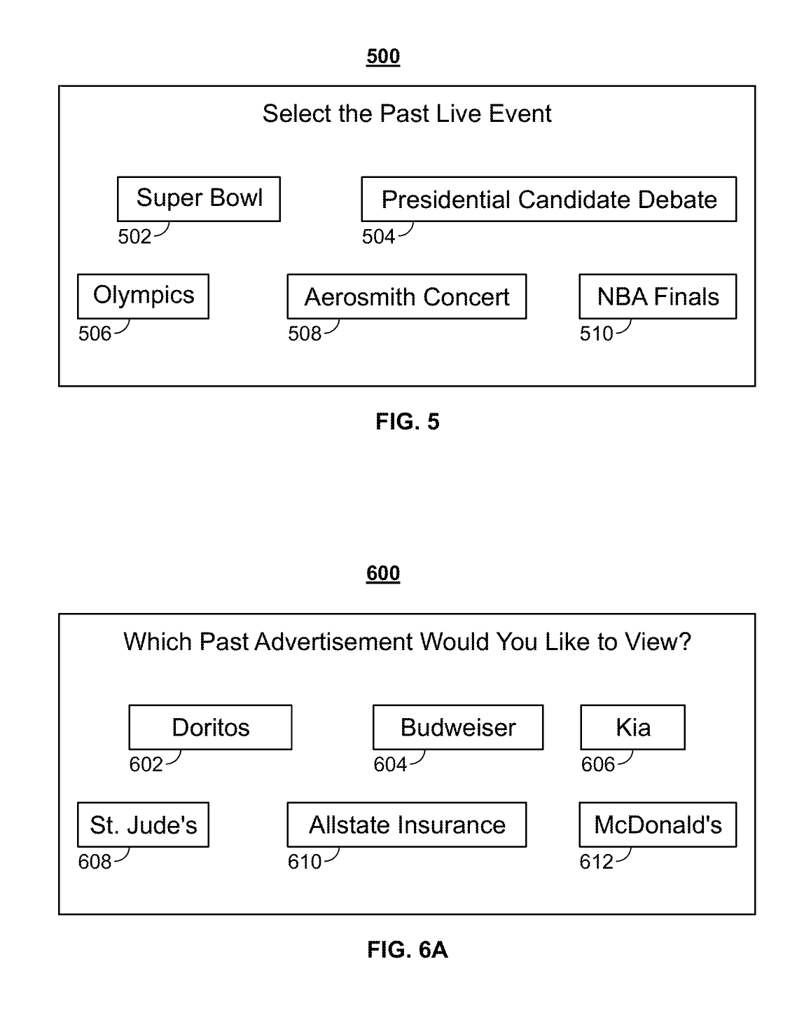

In some embodiments, options region 126 may include a selectable option 128 to display options for inserting content into a stream of video signals. If a user selects selectable option 128, control circuitry on a user equipment device may provide one or more display screens of options for what type of content to insert and when the content should be inserted into a stream of video signals. Illustrative display screens of options are discussed below with respect to FIGS. 5-8. In some embodiments, the selection of a selectable option to display options for inserting content into a stream of video signals may be received by control circuitry on a first user equipment device, and in response to receiving the selection, one or more display screens of options may be provided for display by control circuitry on a second user equipment device that acts as a second screen device. Using a second user equipment device, such as a mobile device, as a second screen device may allow the user to view program listings display 100 on the first user equipment device while viewing content insertion options on the second screen device, or view program listings display 100 on the second screen device while viewing content insertion options on the first user equipment device.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

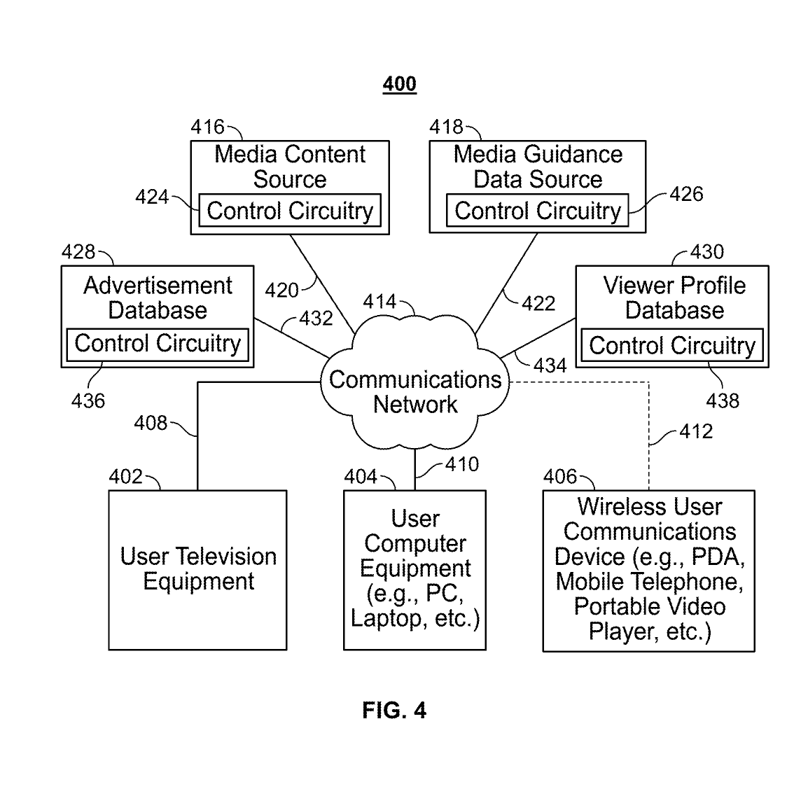

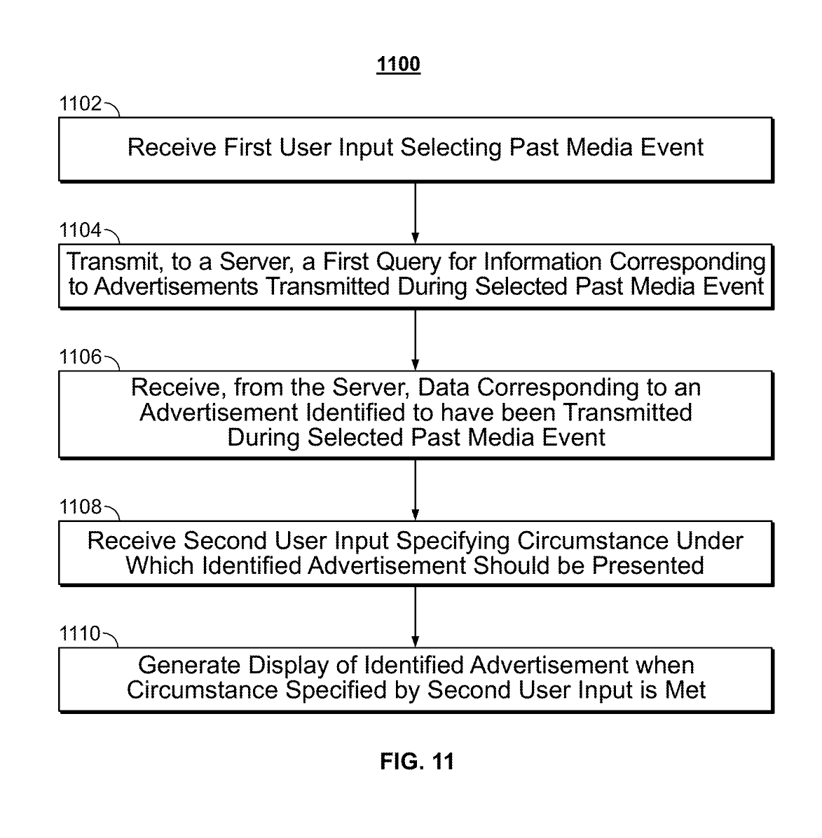

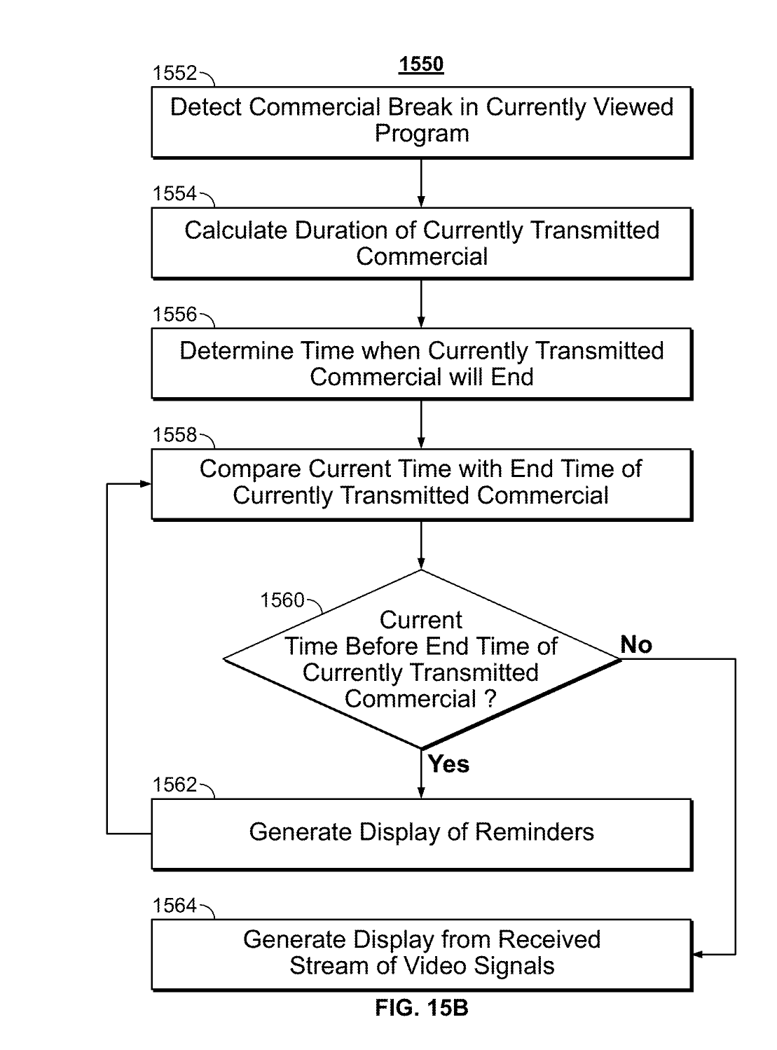

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. The user profile information may also be used to identify content to insert into a stream of video signals, as discussed with respect to FIGS. 11 and 15A. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200, the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

In some embodiments, selectable options 202 may include a selectable option 218 to display options for inserting content into a stream of video signals. If a user selects selectable option 218, control circuitry on a user equipment device may provide one or more display screens of options for what type of content to insert and when the content should be inserted into a stream of video signals. Illustrative display screens of options are discussed below with respect to FIGS. 5-8. In some embodiments, the selection of a selectable option to display options for inserting content into a stream of video signals may be received by control circuitry on a first user equipment device, and in response to receiving the selection, one or more display screens of options may be provided for display by control circuitry on a second user equipment device that acts as a second screen device. Using a second user equipment device, such as a mobile device, as a second screen device may allow the user to view video mosaic display 200 on the first user equipment device while viewing content insertion options on the second screen device, or view video mosaic display 200 on the second screen device while viewing content insertion options on the first user equipment device.

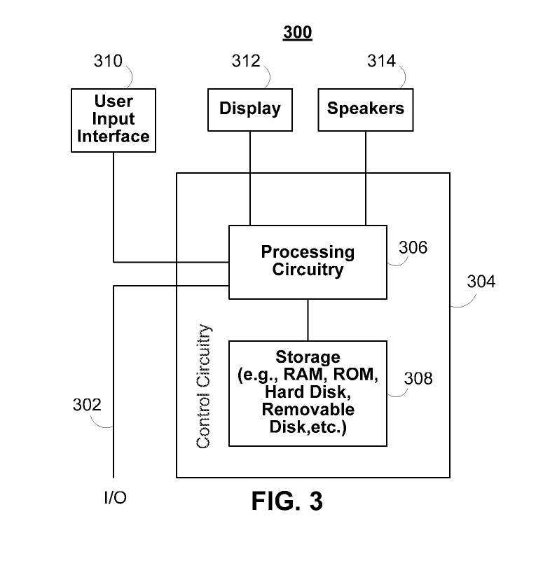

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may identify media content of interest to a user. In some embodiments, control circuitry 304 may identify media content that is similar to media content the user has previously requested or consumed on user equipment device 300 or another user equipment device. In some embodiments, control circuitry 304 may receive recommendations of media content from a friend or family member of the user or by a content source, such as Netflix or iTunes, via I/O path 302. In some embodiments, control circuitry 304 may identify media content that is popular among the user's friends.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any digital storage device (e.g., random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, gaming consoles, gaming media, or any other suitable fixed or removable storage devices, and/or any combination of the same) for storing electronic data, computer software, or firmware. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, gesture-based interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be a high definition display. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

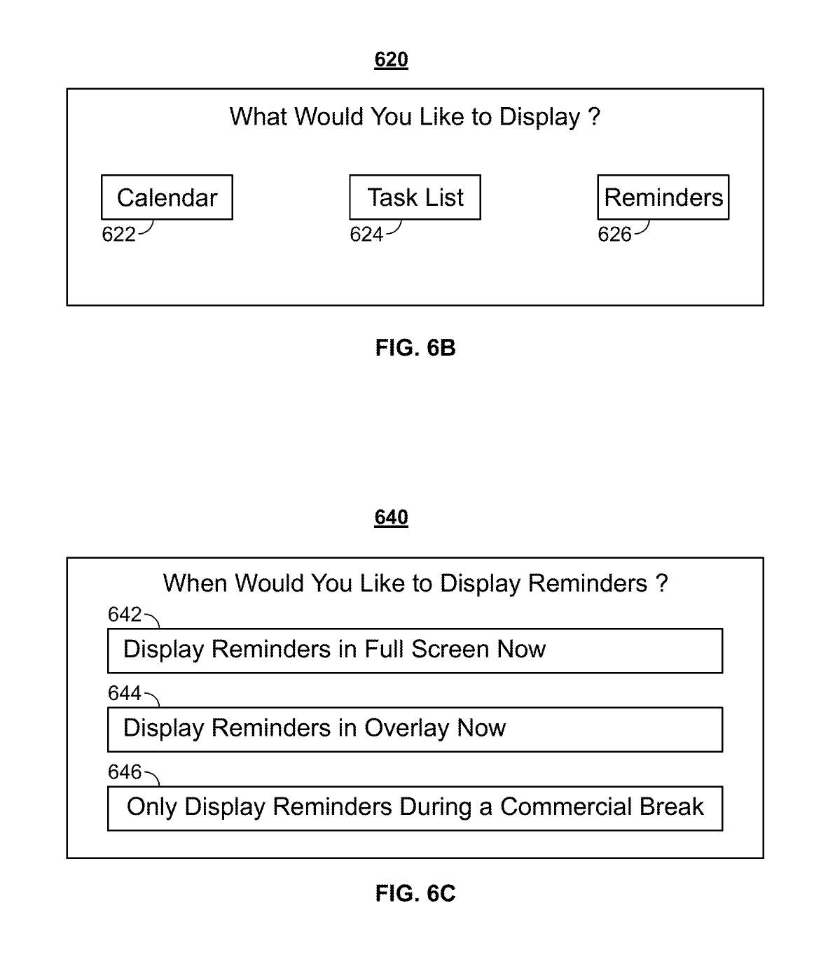

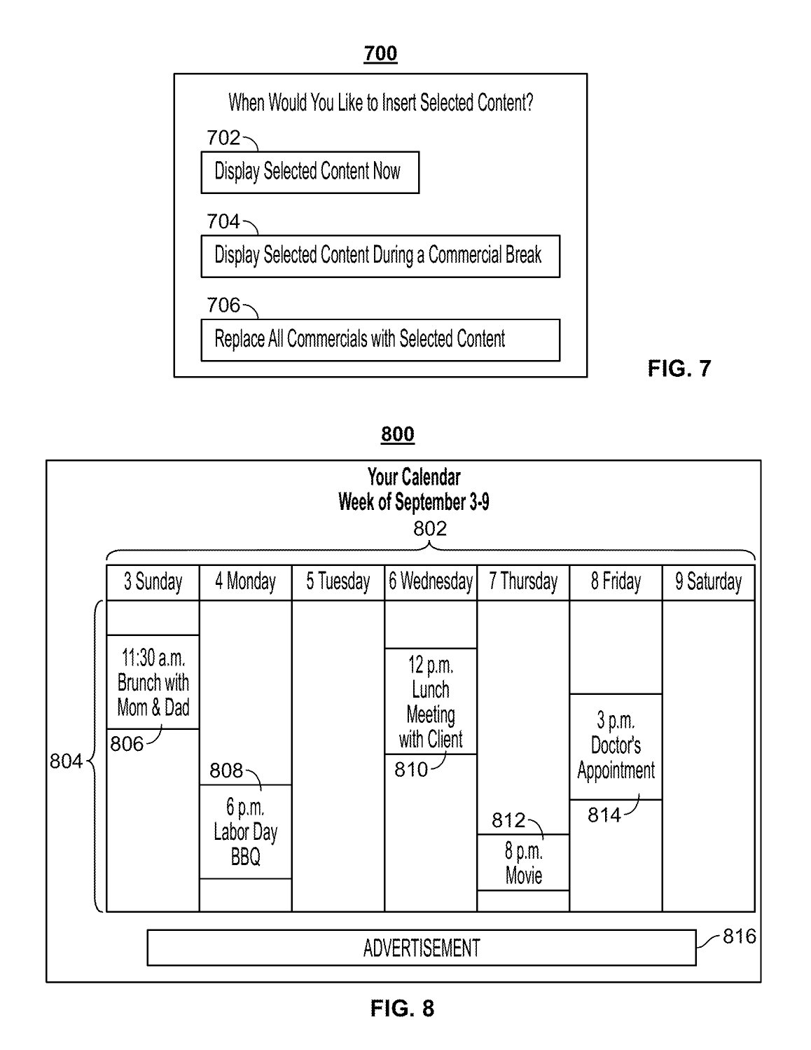

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device provides additional options for customizing the user's experience on the first screen device. For example, a screen first device may be used to display options for what content to insert into a stream of video signals (e.g., display screen 600 of FIG. 6A), while a second screen device is used to display options for when to insert selected content into the stream of video signals (e.g., display screen 700 of FIG. 7). In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, advertisement database 428, and viewer profile database 430 coupled to communications network 414 via communication paths 420, 422, 432, and 434 respectively. Paths 420, 422, 432, and 434 may include any of the communication paths described above in connection with paths 408, 410, and 412. Communications with the content source 416, media guidance data source 418, advertisement database 428, and viewer profile database 430 may be exchanged over one or more communications paths, but are shown as a single path in FIG. 4 to avoid overcomplicating the drawing. In addition, there may be more than one of each of content source 416, media guidance data source 418, advertisement database 428, and viewer profile database 430, but only one of each is shown in FIG. 4 to avoid overcomplicating the drawing. (The different types of each of these sources are discussed below.) If desired, two or more of content source 416, media guidance data source 418, advertisement database 428, and viewer profile database 430 may be integrated as one source device. Although communications between content source 416, media guidance data source 418, advertisement database 428, and viewer profile database 430 with user equipment devices 402, 404, and 406 are shown as through communications network 414, in some embodiments, content source 416, media guidance data source 418, advertisement database 428, and viewer profile database 430 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety. In some embodiments, content source 416 may include control circuitry 424. Control circuitry 424 may be implemented in content source 416 in a similar manner as control circuitry 304 is implemented in user equipment device 300 of FIG. 3.

Media guidance data source 418 may provide media guidance data, such as the media guidance data described above. Media guidance application data may be provided to the user equipment devices using any suitable approach. In some embodiments, media guidance data source 418 may include control circuitry 426. Control circuitry 426 may be implemented in media guidance data source 418 in a similar manner as control circuitry 304 is implemented in user equipment device 300 of FIG. 3. In some embodiments, the guidance application may be a stand-alone interactive television program guide that receives program guide data via a data feed (e.g., a continuous feed or trickle feed). Program schedule data and other guidance data may be transmitted using control circuitry 426 and provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Advertisement database 428 may provide advertisements, such as commercials transmitted during commercial breaks of programs and banner and panel advertisements (e.g., advertisement 124) in display screens used to provide media guidance data. Advertisements may be provided to the user equipment devices using any suitable approach. In some embodiments, advertisement database 428 may include control circuitry 436. Control circuitry 436 may be implemented in advertisement database 428 in a similar manner as control circuitry 304 is implemented in user equipment device 300 of FIG. 3. Advertisements, including video commercials and banner and panel advertisements, may be transmitted using control circuitry 436 and provided to the user equipment on a television channel sideband, using an in-band digital signal, using an out-of-band digital signal, or by any other suitable data transmission technique. Commercials and other advertisements may be provided to user equipment on multiple analog or digital television channels.

In some embodiments, advertisements from advertisement database 428 may be provided to users' equipment using a client-server approach. For example, a user equipment device may pull an advertisement from a server, or a server may push an advertisement to a user equipment device. In some embodiments, a guidance application client residing on the user's equipment may initiate sessions with advertisement database 428 to obtain advertisements when needed, e.g., when the panel or banner advertisements in a media guidance display screen are out of date or when the user equipment device receives a request from the user to insert content into a stream of video signals. Advertisements may be provided to the user equipment with any suitable frequency (e.g., continuously, daily, a user-specified period of time, a system-specified period of time, in response to a request from user equipment, etc.).

Viewer profile database 430 may provide personalized information about a viewer, such as a user's personal calendar, personal task list, or list of reminders. Information about a viewer may be provided to the user equipment devices using any suitable approach. In some embodiments, viewer profile database 430 may include control circuitry 438. Control circuitry 438 may be implemented in viewer profile database 430 in a similar manner as control circuitry 304 is implemented in user equipment device 300 of FIG. 3. Information about a viewer may be transmitted using control circuitry 438 and provided to the user equipment on a television channel sideband, using an in-band digital signal, using an out-of-band digital signal, or by any other suitable data transmission technique. Information about a viewer may be provided to user equipment on multiple analog or digital television channels.

In some embodiments, information from viewer profile database 430 may be provided to users' equipment using a client-server approach. For example, a user equipment device may pull information about a viewer from a server, or a server may push information about a viewer to a user equipment device. In some embodiments, a guidance application client residing on the user's equipment may initiate sessions with viewer profile database 430 to obtain information about a viewer when needed, e.g., when the user equipment device receives a request from the user to insert content into a stream of video signals. Personalized information about a viewer may be provided to the user equipment with any suitable frequency (e.g., continuously, daily, a user-specified period of time, a system-specified period of time, in response to a request from user equipment, etc.).

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content, guidance data, and personalized viewer information may communicate with each other for the purpose of accessing content, providing media guidance, and customizing a media viewing experience. The embodiments described herein may be applied in any one or a subset of these approaches, or in a system employing other approaches for delivering content, providing media guidance, and customizing a media viewing experience. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content, obtain media guidance, and customize a media viewing experience. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, insertion of content, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with any of content source 416, advertisement database 428, and viewer profile database 430 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416, one or more media guidance data sources 418, one or more of advertisement databases 428, and one or more of viewer profile databases 430. In addition or in the alternative, the remote computing sites may include other user equipment devices, such as user television equipment 402, user computer equipment 404, and wireless user communications device 406. For example, the other user equipment devices may provide access to a stored copy of a video (e.g., a commercial or a scheduled program), a streamed video, or a user's personal calendar, task list, or list of reminders. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

A user may take advantage of available cloud resources to customize the user's media viewing experience. For example, instead of watching commercials transmitted to a user equipment device by default, the user may choose to watch commercials stored on an advertisement database 428 that are better suited to the user's interests. Commercials of interest to a user may be those transmitted during a past media event. A past media event may be a past live event (e.g., a National Football League (NFL) Super Bowl, during which some of the most entertaining commercials of each year are transmitted) or a non-live event (e.g., a previous airing of a movie or television show).

FIG. 5 shows an illustrative display screen 500 of options for a past live event. Display screen 500 includes selectable options 502, 504, 506, 508, and 510, each representing a past live event. In some embodiments, a display screen of options for a past live event may include options representing past live broadcasts of sporting events, such as a Super Bowl (option 502), Olympics (option 506), or National Basketball Association (NBA) Finals (option 510). In some embodiments, a display screen of options for a past live event may include options representing past live broadcasts of political events, such as a debate between presidential candidates (option 504). In some embodiments, a display screen of options for a past live event may include options representing past live broadcasts of a musical event, such as a concert played by the group Aerosmith (option 508).

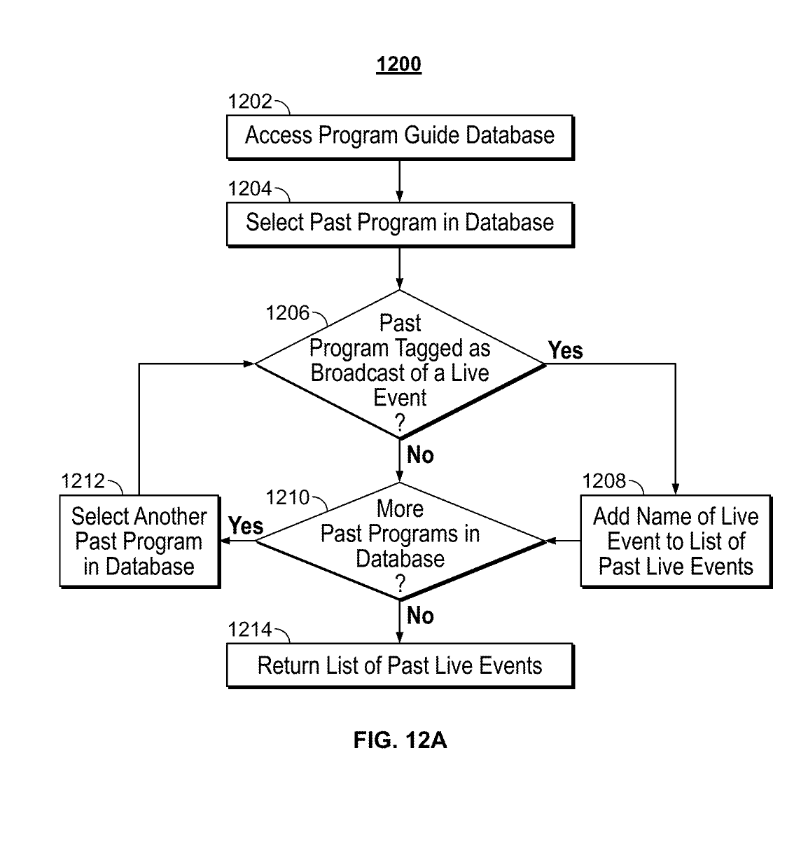

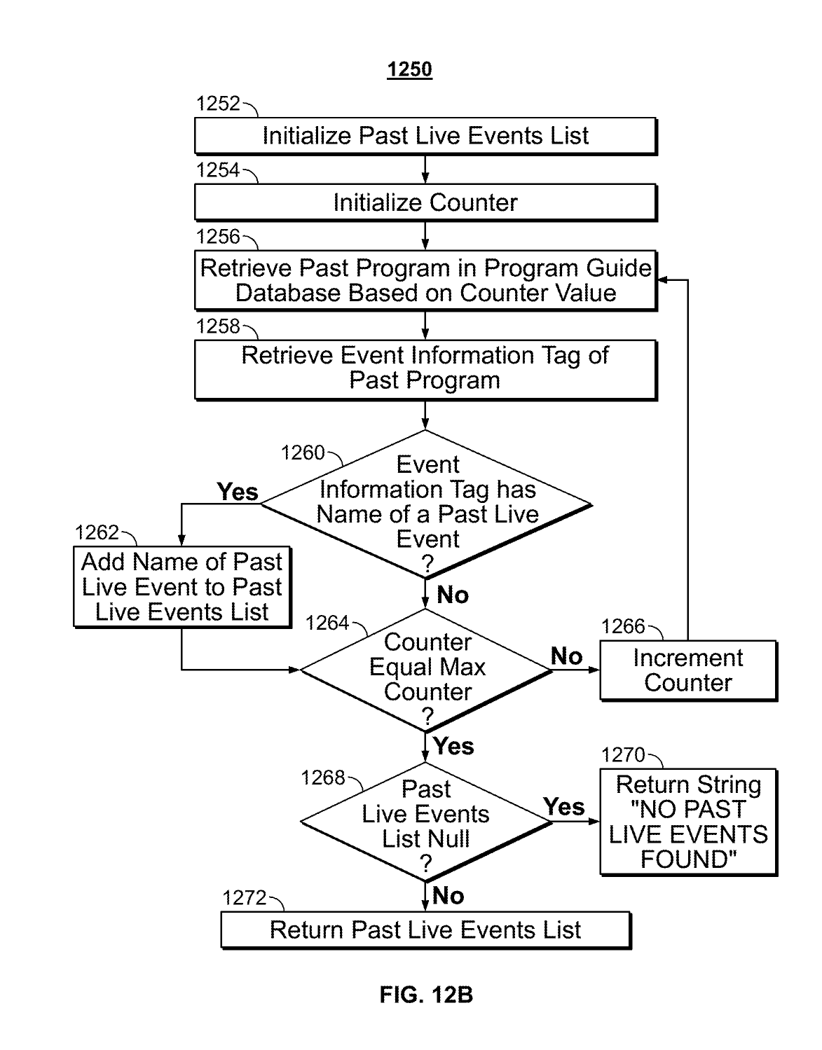

Display screen 500 may be generated by or generated based on an instruction from control circuitry 304 of a user equipment device 300 or control circuitry 426 of a media guidance data source 418. In some embodiments, display screen 500 may be generated based on a list of past live events returned from a search of a media guidance data source 418, such as a search discussed below with respect to FIGS. 12A and 12B. In some embodiments, display screen 500 may appear on a display 312 of a user equipment device.

In some embodiments, a user may select one of options 502, 504, 506, 508, and 510 by moving a cursor or highlight region over one of the displayed options and then pressing a designated button on a user input device (e.g., “OK” button on a remote control, left button on a computer mouse). Any other suitable means for selecting an option may be used (e.g., voice recognition software, detecting motions of a user, sensing a user selection on a touch-screen device). A user selection of an option from display screen 500 may be received by control circuitry 304 of a user equipment device.

After selecting a past live event, a user may want to select one or more particular advertisements transmitted during the past live event to view. FIG. 6A shows an illustrative display screen 600 of options for past advertisements. In some embodiments, display screen 600 may appear on a display 312 of a user equipment device. Display screen 600 includes selectable options 602, 604, 606, 608, 610, and 612, each representing an advertisement presented in the past. In some embodiments, a display screen of options for past advertisements may include options representing advertisements for food and drink products, such as Doritos (option 602), Budweiser (option 604), or McDonald's (option 612). In some embodiments, a display screen of options for past advertisements may include options representing advertisements for various car brands, such as Kia (option 606). In some embodiments, a display screen of options for past advertisements may include options representing advertisements for services, such as St. Jude's Hospital (option 608) or Allstate Insurance (option 610).

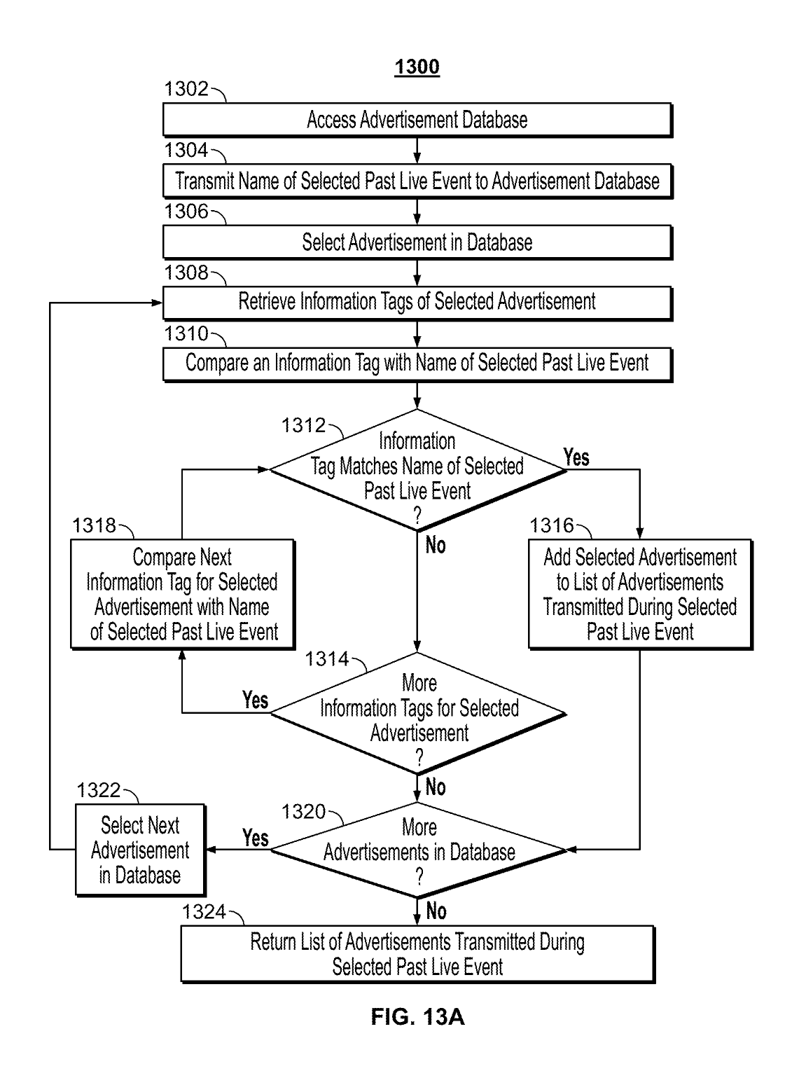

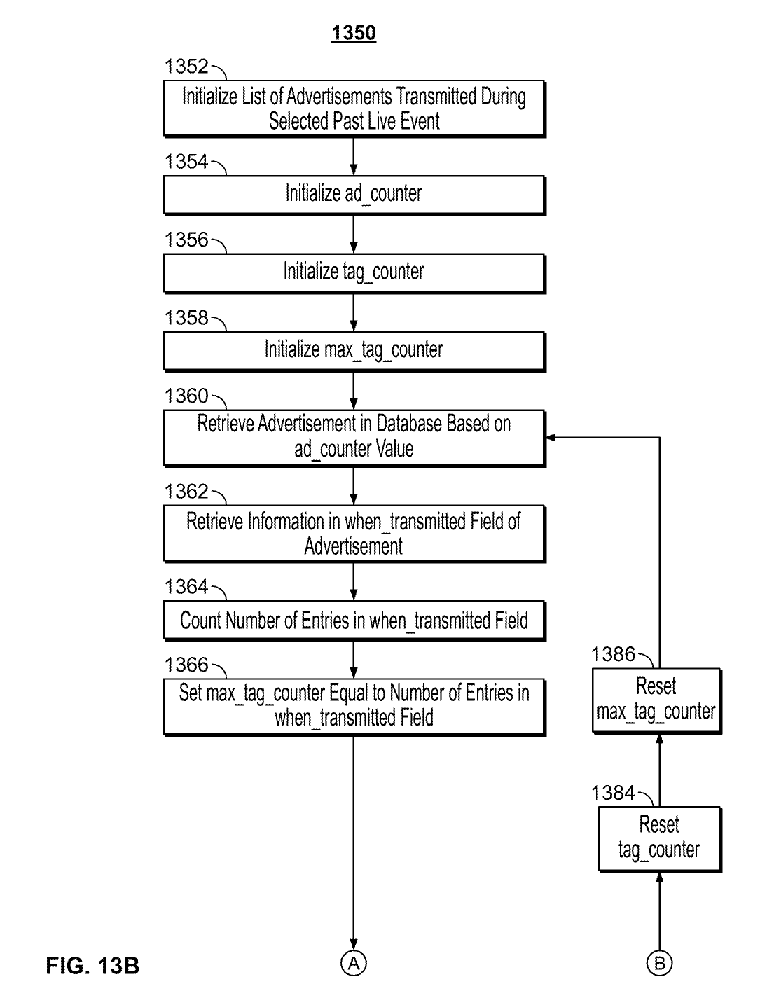

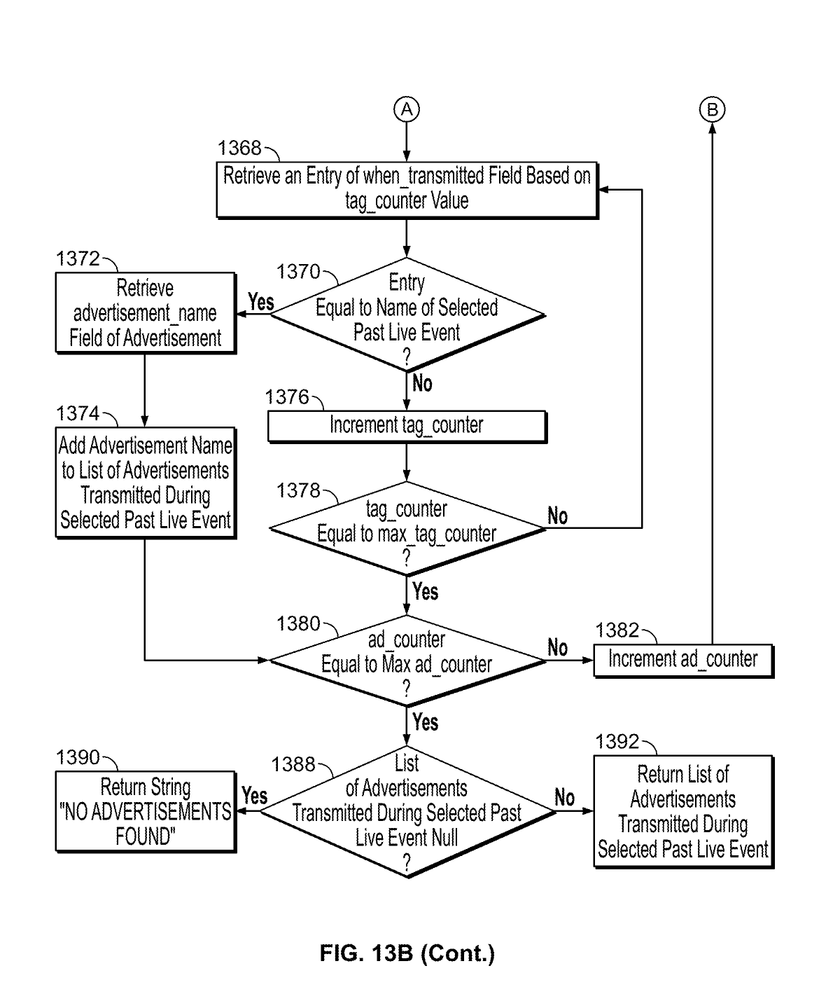

Display screen 600 may be generated by or generated based on an instruction from control circuitry 304 of a user equipment device 300 or control circuitry 436 of an advertisement database 428. In some embodiments, display screen 600 may be generated based on a list of past advertisements returned from a search of advertisement database 428, such as a search discussed below with respect to FIGS. 13A and 13B. In some embodiments, display screen 600 may be generated after a user selects a previously aired non-live program (e.g., series finale of “Friends”) and inputs a command to replace default commercials with commercials that were transmitted during the selected program.

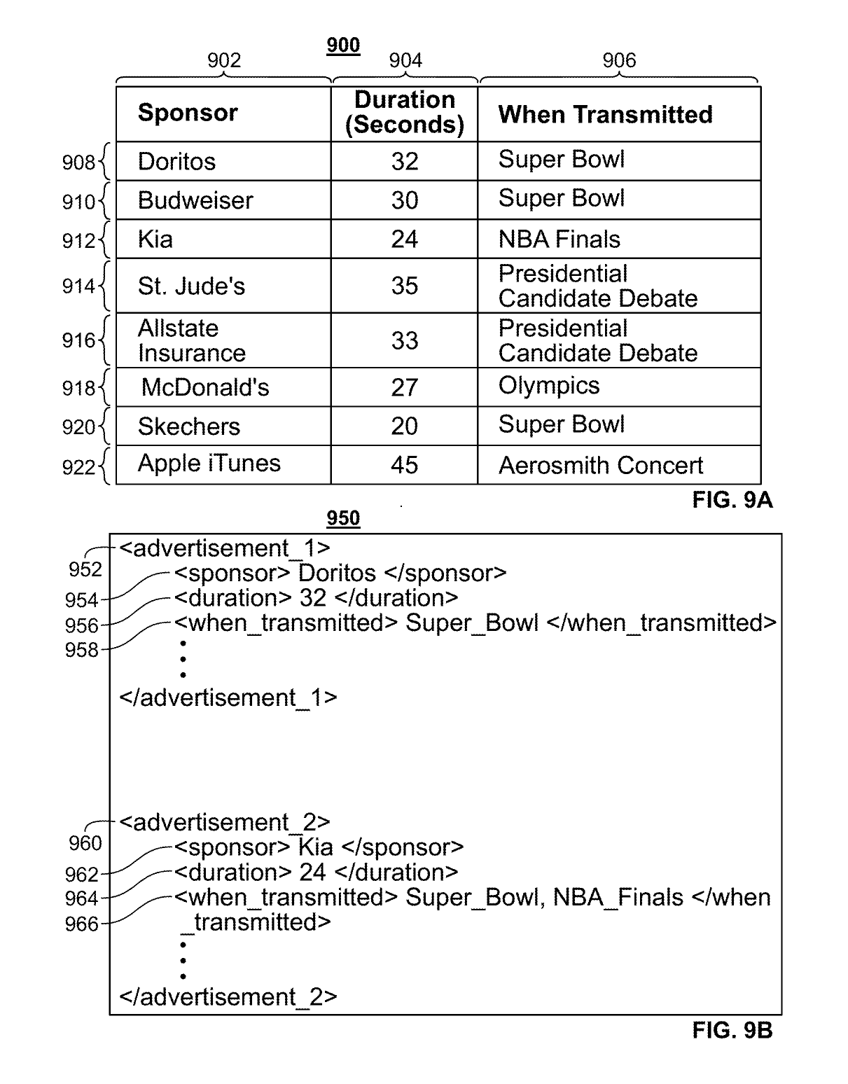

In some embodiments, control circuitry 436 may identify advertisements based on a targeted advertising scheme as well as based on a user-selected past live event. For example, by analyzing a user profile (e.g., a user profile received from viewer profile database 430 or user equipment device 402, 404, or 406), control circuitry 436 may determine that a user likes eating fast food. Therefore, after control circuitry 436 identifies past advertisements that were transmitted during a user-selected past live event, control circuitry 436 may also determine which of the identified past advertisements are advertisements for fast food (e.g., McDonald's, Burger King, Wendy's). To determine what an advertisement is promoting, control circuitry 436 may analyze information tags associated with the advertisement, as further discussed below with respect to FIGS. 9A and 9B. In some embodiments, control circuitry 436 may identify advertisements relevant to a user profile while searching for advertisements transmitted during a user-selected past event (e.g., examine information tags for sponsor information as well as the name of a media event during which an advertisement was transmitted), such that control circuitry 436 only needs to make one pass through the advertisements stored in advertisement database 428.

By identifying advertisements based on a targeted advertisement scheme, control circuitry 436 may create a list of past advertisements that were transmitted during a user-selected past live event and that promote products or services of interest to the user. Control circuitry 436 may transmit such a list to control circuitry 304, which may then generate display options corresponding to the listed advertisements. For example, the advertisements corresponding to the options in display screen 600 of FIG. 6A may each promote a product or service that a user is interested in buying, as determined based on the user's profile.

In some embodiments, a user may select one of options 602, 604, 606, 608, 610, and 612 by moving a cursor or highlight region over one of the displayed options and then pressing a designated button on a user input device (e.g., “OK” button on a remote control, left button on a computer mouse). Any other suitable means for selecting an option may be used (e.g., voice recognition software, detecting motions of a user, sensing a user selection on a touch-screen device). A user selection of an option from display screen 600 may be received by control circuitry 304 of a user equipment device.

In some embodiments, after control circuitry 304 receives a list of advertisements of interest to a user that were transmitted during a user-selected past live event, control circuitry 304 may automatically select one or more of the listed advertisements instead of displaying to the user options corresponding to the listed advertisements. In some embodiments, control circuitry 304 may select an advertisement that has a high probability of being of interest to the user. In some embodiments, the probability may be an affinity metric calculated by control circuitry 304. In some embodiments, control circuitry 304 may select an advertisement that the user has not seen before. Control circuitry 304 may determine whether the user has seen an advertisement before by examining the user's viewing history, which may be part of a user profile stored in viewer profile database 430 or locally in a memory of a user equipment device. Control circuitry 304 may insert the advertisement(s) automatically selected by control circuitry 304 into a stream of video signals at an appropriate time, as determined by a user command and/or as determined by control circuitry 304. It should be understood that any of the steps of automatically selecting one or more advertisements may be performed by control circuitry 436.

A viewer may wish to select content other than advertisements for viewing. FIG. 6B shows an illustrative display screen 620 of options for displaying non-advertisement content. In some embodiments, display screen 620 may appear on a display 312 of a user equipment device. Display screen 620 includes selectable options 622, 624, and 626. Option 622 is an option to display a calendar. In some embodiments, in response to a user selection of option 622, a user's personal calendar may be displayed. The displayed calendar may include the user's appointments or scheduled events over the course of a day, week, or month, as discussed below with respect to FIG. 8. In some embodiments, in response to a user selection of option 622, the user may be given a set of options for when a calendar should be displayed (e.g., immediately or during the next commercial break).

Option 624 is an option to display a task list. In some embodiments, in response to a user selection of option 624, a user's personal task list may be displayed. The displayed task list may include errands that the user needs to run (e.g., picking up dry cleaning, mailing a package at the post office), information that the user needs to obtain (e.g., looking up rates for a home equity loan), or a grocery list. In some embodiments, in response to a user selection of option 624, the user may be given a set of options for when a task list should be displayed (e.g., immediately or during the next commercial break).

Option 626 is an option to display reminders. In some embodiments, in response to a user selection of option 624, a display screen of the user's reminders may be displayed. The reminders may include reminders to watch certain programs (e.g., a sports game or movie), a reminder of an upcoming appointment (e.g., doctor's appointment) for the user, a reminder for a task the user needs to perform (e.g., take a cake out of the oven), any other type of reminder, or any combination thereof. In some embodiments, reminders may include items from the user's personal task list. In some embodiments, in response to a user selection of option 626, the user may be given a set of options for when a task list should be displayed (e.g., immediately or during the next commercial break).

Display screen 620 may be generated by or generated based on an instruction from control circuitry 304 of a user equipment device 300. In some embodiments, display screen 620 may be generated after a user indicates a desire to insert content into a stream of video signals, such as by selecting option 128 from display screen 100 of FIG. 1 or option 218 from display screen 200 of FIG. 2.

In some embodiments, a user may select one of options 622, 624, and 626 by moving a cursor or highlight region over one of the displayed options and then pressing a designated button on a user input device (e.g., “OK” button on a remote control, left button on a computer mouse). Any other suitable means for selecting an option may be used (e.g., voice recognition software, detecting motions of a user, sensing a user selection on a touch-screen device). A user selection of an option from display screen 620 may be received by control circuitry 304 of a user equipment device.

In some embodiments, after selecting content for display, a user may select when the selected content should be displayed. FIG. 6C shows an illustrative display screen 640 of options for when to display reminders. In some embodiments, display screen 640 may appear on a display 312 of a user equipment device 300. Display screen 640 includes selectable options 642, 644, and 646, each representing a circumstance under which reminders should be displayed.

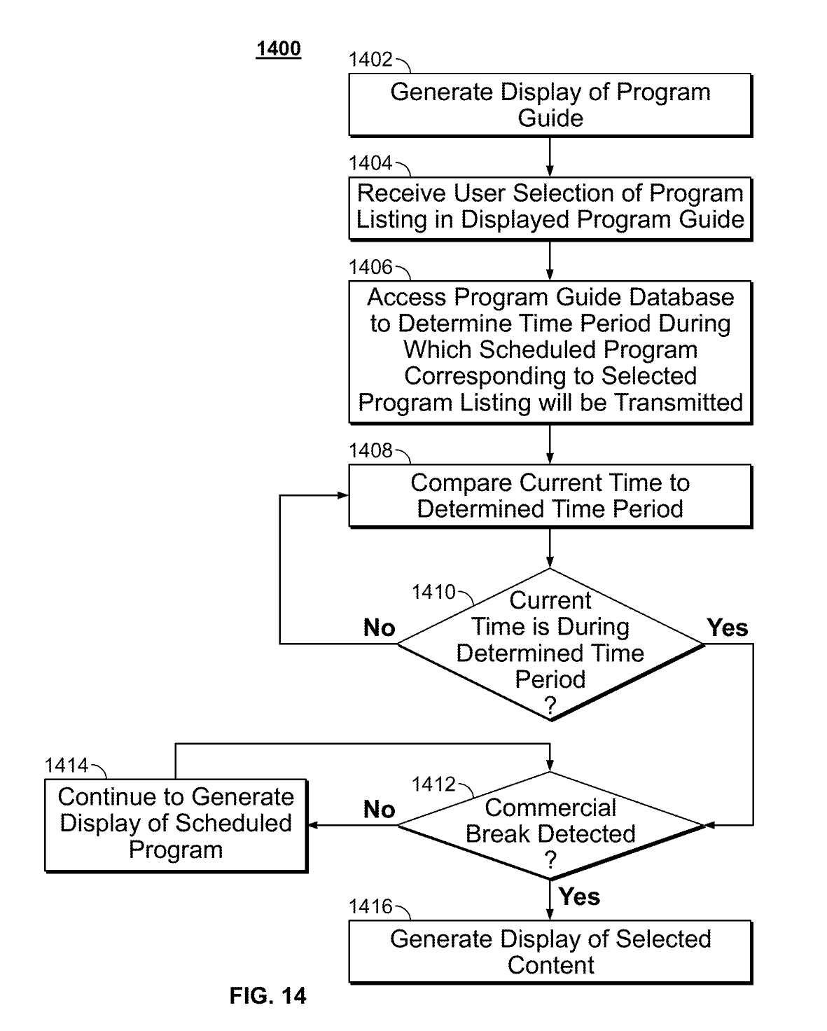

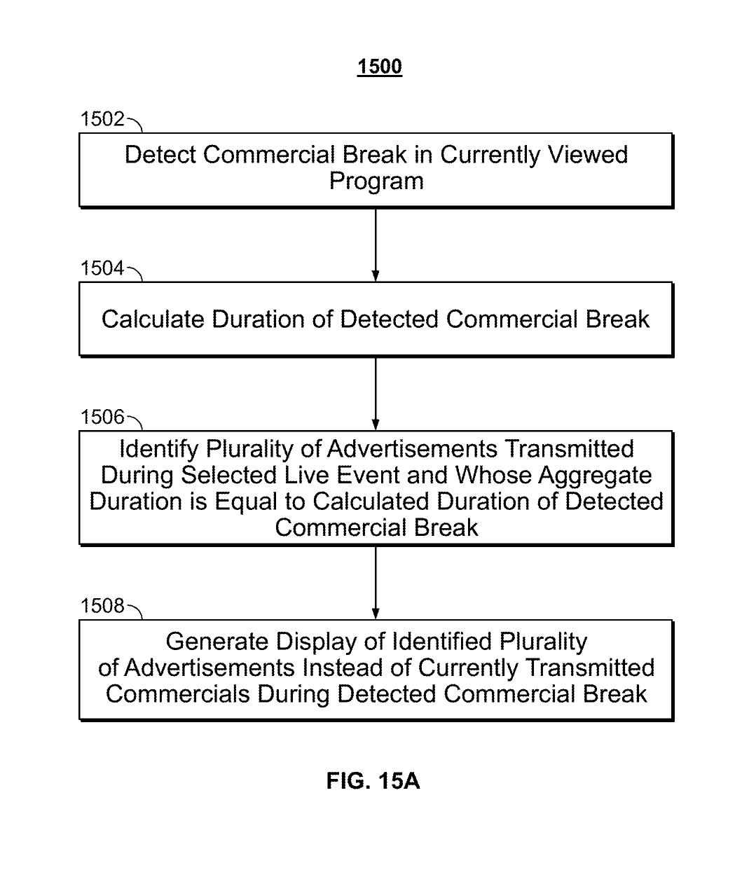

Option 642 is an option to display reminders immediately in a full screen view. In some embodiments, in response to a user selection of option 642, a display screen of the user's reminders will fill the entire display area of user equipment device 300. Option 644 is an option to display reminders immediately in an overlay. In some embodiments, in response to a user selection of option 644, a display screen of the user's reminders will be generated over part of a display area of user equipment device 300. For example, reminders may be displayed in a pop-up window or overlay in the bottom third of the display area such that the user may simultaneously watch a program and view reminders. Option 646 is an option to only display reminders during a commercial break. In some embodiments, after a user selects option 646, the user's reminders will not be displayed immediately but rather during the next detected commercial break or during a commercial break specified by the user, as discussed below with respect to FIGS. 14 and 15B.

Display screen 640 may be generated by or generated based on an instruction from control circuitry 304 of a user equipment device 300. In some embodiments, display screen 640 may be displayed after a user selects option 626 from display screen 620 of FIG. 6B. It should be understood that a display screen analogous to display screen 640 may be generated in response to a user selection of option 622 or option 624 from display screen 620 of FIG. 6B.

In some embodiments, a user may select one of options 642, 644, and 646 by moving a cursor or highlight region over one of the displayed options and then pressing a designated button on a user input device (e.g., “OK” button on a remote control, left button on a computer mouse). Any other suitable means for selecting an option may be used (e.g., voice recognition software, detecting motions of a user, sensing a user selection on a touch-screen device). A user selection of an option from display screen 640 may be received by control circuitry 304 of a user equipment device.

FIG. 7 shows another illustrative display screen 700 of options for when to insert selected content, such as an advertisement selected from display screen 600 or a user's personal calendar, task list, or list of reminders. Display screen 700 includes selectable options 702, 704, and 706, each representing when selected content should be viewed. Selected content, such as a past advertisement or information specific to a user, may be displayed immediately (option 702) or during a commercial break of a scheduled program (option 704). In some embodiments, a user may select an option to replace all commercials transmitted during commercial breaks of a scheduled program with selected content (option 706).

Display screen 700 may be generated by, or generated based on an instruction from, control circuitry 304 of a user equipment device 300 or control circuitry 438 of a viewer profile database 438. In some embodiments, display screen 700 may be generated after a user selects content, such as a past advertisement transmitted during a past live event or a user's personal calendar, to insert into a stream of video signals. In some embodiments, display screen 700 may appear on a display 312 of a user equipment device.

In some embodiments, a user may select one of options 702, 704, and 706 by moving a cursor or highlight region over one of the displayed options and then pressing a designated button on a user input device (e.g., “OK” button on a remote control, left button on a computer mouse). Any other suitable means for selecting an option may be used (e.g., voice recognition software, detecting motions of a user, sensing a user selection on a touch-screen device). A user selection of an option from display screen 700 may be received by control circuitry 304 of a user equipment device.

In some embodiments, control circuitry 304 may receive a user selection of a program during which the user desires to insert selected content. For example, after receiving a user selection of option 704 or 706 from display screen 700 of FIG. 7, control circuitry 304 may generate a display of options for a program during whose commercial break(s) selected content should be inserted. In some embodiments, the program may be selected from a media guidance data display screen, such as display screen 100 or 200. For example, control circuitry 304 may receive a user selection of the show “Friends” from display screen 100. If control circuitry 304 had also received a user selection of option 602 from display screen 600 and a user selection of option 704 from display screen 700, control circuitry 304 will insert video of a Doritos commercial into a stream of video signals received during a commercial break of “Friends” such that a Doritos commercial is displayed instead of one of the default commercials transmitted during the show “Friends.”

If control circuitry 304 had instead received a user selection of option 502 from display screen 500 and a user selection of option 706 from display screen 700, and if advertisements had been automatically selected by control circuitry 304 or control circuitry 436 as discussed above with respect to FIG. 6A, then control circuitry 304 will insert video of various commercials transmitted during the Super Bowl into a stream of video signals received during all commercial breaks of the show “Friends.” The result will be that during all commercial breaks of “Friends,” commercials transmitted during the Super Bowl are displayed instead of the default commercials transmitted during the show “Friends.” In some embodiments, the total duration of all commercials transmitted during the Super Bowl and selected for insertion may be longer than the total duration of a selected program like “Friends.” Control circuitry 304 may detect this discrepancy and generate a display of options to the viewer for when to display the selected Super Bowl commercials. The options may include, for example:

i) selecting another program during which to display Super Bowl commercials (the selection can be performed either by the user or by control circuitry 304),

ii) displaying Super Bowl commercials during commercial breaks of “Friends” as well as during commercial breaks of the show after “Friends” (i.e., “Will and Grace”), and

iii) displaying Super Bowl commercials during commercial breaks of “Friends” as well as during commercial breaks of the show before “Friends,” if the show before “Friends” has not yet ended.

The displayed options may include displaying Super Bowl commercials during more than two shows (e.g., displaying Super Bowl commercials during commercial breaks of “Friends” and the two shows after it) if necessary. In some embodiments, control circuitry 304 may replace only some default commercials with selected Super Bowl commercials according to a targeted advertising scheme. Under the targeted advertising scheme, default commercials of interest to the user may be displayed during commercial breaks, and other default commercials will be replaced with selected Super Bowl commercials. For example, control circuitry 304 may examine metadata corresponding to a default commercial and determine that a product promoted by the default commercial is of interest to the user. If such a determination is made, the default commercial will be displayed instead of being replaced by a Super Bowl commercial. The determination of whether a default commercial is of interest to a user may be made based on information in a user profile received from viewer profile database 430 or stored locally on a user equipment device.

FIG. 8 shows an illustrative display screen 800 of a user's personal calendar. Calendar display screen 800 includes dates 802 of a particular week and a scheduled events region 804 where a user's scheduled events for the particular week are displayed. Scheduled events region 804 in calendar display screen 800 includes scheduled events 806, 808, 810, 812, and 814. Scheduled event 806 is a brunch with the user's parents. Scheduled event 808 is a barbecue to celebrate Labor Day. Scheduled event 810 is a lunch meeting with a client. Scheduled event 812 is a screening of a movie. Scheduled event 814 is a doctor's appointment.

A user's personal calendar may be displayed in a weekly view, as illustrated in FIG. 8, in which a user's scheduled events during a particular week are displayed. In some embodiments, a user's personal calendar may be displayed in a daily view, which shows a user's scheduled events for a particular day. In some embodiments, a user's personal calendar may be displayed in a monthly view, which shows a user's scheduled events for a particular month.

In some embodiments, calendar display screen 800 may be displayed during a commercial break of a currently viewed program after a user selection is received to insert content into a stream of video signals. For example, control circuitry 304 of a user equipment device may receive a user selection of selectable option 128 or 218 from a media guidance display. Control circuitry 304 may then generate a display of options for what content to insert. The displayed options may include a past advertisement, a user's personal calendar, a user's personal task list, and a user's list of reminders. In some embodiments, after receiving a user selection to insert a user's personal calendar into a stream of video signals, control circuitry 304 may generate a display of an options screen, such as display screen 700, to allow the user to specify circumstances under which the calendar display screen should be inserted into a stream of video signals. If control circuitry 304 receives a user selection of an option to display a user's personal calendar during a commercial break (e.g., option 704 in display screen 700 of FIG. 7), control circuitry 304 may generate a display of a calendar display screen 800 when a commercial break is detected during a currently viewed program.

A commercial break may be detected using any suitable means. In some embodiments, control circuitry 304 may analyze metadata received with a stream of video signals to determine the nature of the content in the stream. Control circuitry 304 may detect a commercial break by determining that metadata associated with a currently displayed video signal has changed from describing a scheduled program to describing an advertisement.

In some embodiments, calendar display screen 800 may include advertisement 816. In some embodiments, advertisement 816 may be a banner advertisement or a panel advertisement. In some embodiments, advertisement 816 may have moving images and audio. In some embodiments, advertisement 816 may be a past advertisement selected by a user (e.g., from options screen 600 of FIG. 6A).

In some embodiments, advertisement 816 may have the same sponsor as a video commercial that is part of a default transmission of video signals. For example, if calendar display screen 800 is displayed during a commercial break of a currently viewed program, control circuitry 304 may analyze metadata received via I/O path 302 to determine which commercial would be displayed by default if calendar display screen 800 had not been inserted into the stream of video signals. In some embodiments, control circuitry 304 may generate a display of the default commercial as advertisement 816 in calendar display screen 800. In some embodiments, control circuitry 304 may identify a sponsor of the default commercial and identify another advertisement from the same sponsor to display as advertisement 816 in calendar display screen 800. For example, control circuitry 304 may access advertisement database 428 to obtain a panel or banner advertisement that promotes the same product or service as the default commercial, or that promotes a different product or service of the sponsor of the default commercial. By having some sort of advertisement in calendar display screen 800, a sponsor of a default commercial is still able to promote its brand, products, or services even though a user has chosen to replace the sponsor's default commercial with a personal calendar display.

FIG. 9A shows an illustrative data structure 900 for storing information about advertisements. Data structure 900 may include information about sponsors and durations of advertisements presented in the past, names of events during which various advertisements were transmitted, and any other information about an advertisement. Data structure 900 may include a column 902 of data fields with sponsors of advertisements, a column 904 of data fields with durations (in seconds) of the respective advertisements, and a column 906 of data fields with names of events during which respective advertisements were transmitted. Data fields of a data structure such as data structure 900 may also be referred to herein as “information tags.”

Data structure 900 includes rows 908, 910, 912, 914, 916, 918, 920, and 922, each row corresponding to an advertisement that was transmitted in the past during a broadcast of a live event. In data structure 900, each row has a sponsor field with the name of an entity who paid for the respective advertisement, a duration field with a number representing how many seconds long the advertisement is, and a “when transmitted” field with a name of a media event during which the advertisement was transmitted. The illustrative “when transmitted” fields in column 906 all contain names of past live events, but “when transmitted” fields may also contain names of scheduled programs (e.g., the television show “Friends”). In some embodiments, column 902 of data structure 900 may have more than one data field with the same sponsor name if one sponsor has multiple transmitted advertisements. In some embodiments, a “when transmitted” field in column 906 of data structure 900 may include more than one media event name if a particular advertisement was transmitted during more than one media event (e.g., during a Super Bowl and during the NBA Finals).

In some embodiments, data structure 900 is stored in advertisement database 428. In some embodiments, data structure 900 is stored in a database stored on another external source (e.g., a website on the Internet, a memory of a cloud resource). In some embodiments, data structure 900 may be maintained by control circuitry 436, which may populate data structure 900 by examining metadata of advertisements stored in advertisement database 428. In some embodiments, control circuitry 436 may search fields in data structure 900 to determine which advertisements were transmitted during a particular past live event, as discussed further with respect to FIGS. 13A and 13B.

FIG. 9B shows an illustrative advertisement information data structure 950 that may be used to store information about advertisements. Advertisement information data structure 950 may be stored in an advertisement database (e.g., advertisement database 428) or a database stored on another external source (e.g., a website on the Internet, a memory of a cloud resource). In some embodiments, advertisement information data structure 950 may be maintained by control circuitry 436, which may populate advertisement information data structure 950 by examining metadata of advertisements stored in advertisement database 428.

Each of advertisement fields 952 and 960 of advertisement information data structure 950 may correspond to an advertisement stored in advertisement database 428. Advertisement fields 952 and 960 may each include a name of the corresponding advertisement. In some embodiments, the name of an advertisement may be the same as the name of the advertisement's sponsor. Information data structure 950 may include information about advertisement sponsors (e.g., sponsor fields 954 and 962) and durations (e.g., duration fields 956 and 964), and may also include names of media events during which advertisements were transmitted (e.g., when_transmitted fields 958 and 966). In some embodiments, a when_transmitted field (e.g., when_transmitted field 966) of data structure 950 may include more than one media event name if the corresponding advertisement was transmitted during more than one media event (e.g., during a Super Bowl and during the NBA Finals). A when_transmitted field may include the name of a past live event and/or the name of a scheduled program (e.g., “Friends”). In some embodiments, the when_transmitted field may identify a particular episode of a scheduled program (e.g., “Lost” Season 2, Episode 5).

In some embodiments, data structure 950 may include additional fields with information about what product or service an advertisement is promoting. In some embodiments, data structure 950 may include additional fields with information about names of people (e.g., actors, actresses, professional athletes, talk show hosts) who appear in an advertisement. In some embodiments, data structure 950 may include additional fields with information about where a commercial appears to take place (i.e., setting). Any other information that describes an advertisement may be included in a field of data structure 950. Information in the fields of information data structure 950 may be stored as character strings or any other format suitable for storing alpha-numeric characters. Fields of a data structure 950 may also be referred to herein as “information tags.”

In some embodiments, advertisement information data structure 950 may be used during a search for advertisements with certain characteristics. For example, control circuitry 304 may receive a user input to display advertisements transmitted during a past live event (e.g., the user input may be a selection of one of the past live event options in display screen 500 of FIG. 5). Control circuitry 304 may transmit the name of the selected past live event in a character string, or in any other format suitable for alpha-numeric characters, to advertisement database 428. Control circuitry 436 may receive the past live event name character string and retrieve advertisement information data structure 950 from advertisement database 428. Control circuitry 436 may compare characters in the received character string to information in when_transmitted fields (e.g., when_transmitted fields 958 and 966) in advertisement information data structure 950. If the received character string substantially matches a media event name in a when_transmitted field, control circuitry 436 may return to control circuitry 304 the name of the corresponding advertisement or sponsor (e.g., information in advertisement field 952 or 960, or sponsor field 954 or 962).

In some embodiments, a search for information in a field of data structure 950 that matches a search string (e.g., character string with the name of a selected past live event) may be performed by control circuitry 436 using a fuzzy text matching algorithm. The algorithm may include the step of transforming field information into a character string so that a character-by-character comparison of the search string and the field information string may be performed. In some embodiments, all spaces and punctuation marks may be eliminated from the search string and the field information string before the character-by-character comparison is performed. In some embodiments, all letters in the search string and the field information string may be converted to upper-case characters before the character-by-character comparison is performed. Such modifications of the strings prior to comparison may increase the accuracy of the algorithm. In some embodiments, a field information string may be considered to match the search string if a certain percentage (e.g., 85% or more) of the characters are identical.

In some embodiments, the fuzzy text matching algorithm may involve parsing the search string into syllables or words and then putting the syllables or words into a binary tree. A field information string may also be parsed into syllables or words which are then put into another binary tree. The nodes of the two binary trees may then be compared to determine whether the strings match. Any other suitable technique, such as string tokenization and use of hash tables, may be used in the fuzzy text matching algorithm.

In some embodiments, control circuitry 436 may identify advertisements by conducting a heuristic analysis of fields in advertisement information data structure 950. The heuristic analysis may involve term disambiguation and probabilistic methods, such as those taught in “Artificial Intelligence” by Patrick Henry Winston (published by Addison-Wesley Publishing Company) and “Probability, Random Variables, and Stochastic Processes” by Athanasios Papoulis (published by McGraw-Hill Book Company), which are hereby incorporated by reference in their entireties. It should be understood that any of the steps discussed above for identifying advertisements may be performed by control circuitry 304 of a user equipment device if control circuitry 304 retrieves data structure 950 from an advertisement database 428 or a database stored on another external source.

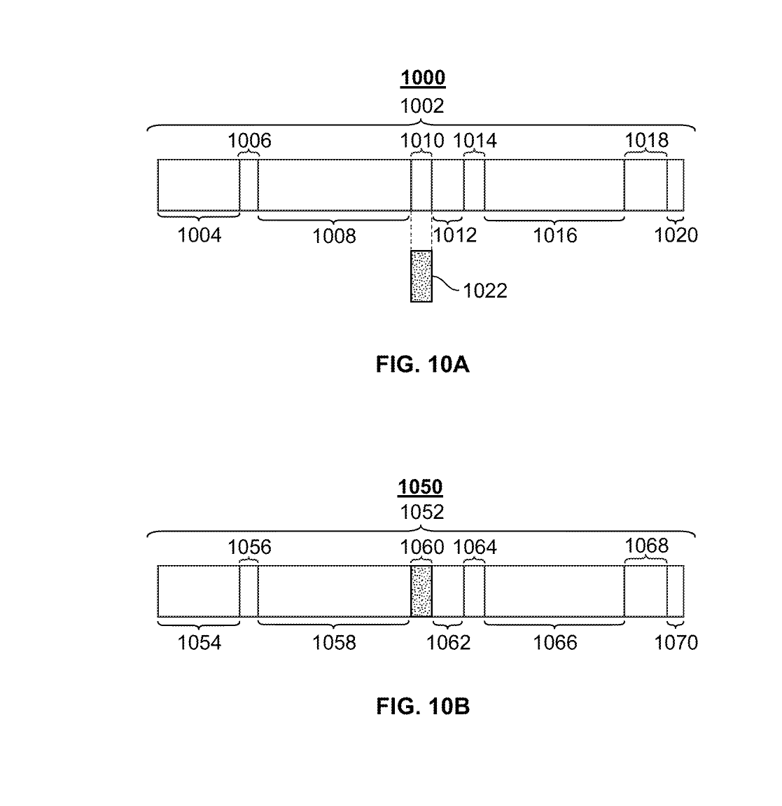

FIGS. 10A and 10B show illustrative schematics 1000 and 1050, respectively, of inserting content into a stream of video signals. Schematic 1000 of FIG. 10A shows a stream of video signals 1002 made up of segments 1004, 1006, 1008, 1010, 1012, 1014, 1016, 1018, and 1020. In some embodiments, segments 1004, 1008, 1016, and 1020 may represent segments of a scheduled program or broadcast live event. In some embodiments, segments 1006, 1010, 1012, 1014, and 1018 may represent commercials transmitted by default to a user equipment device during commercial breaks of a scheduled program or broadcast live event. Segment 1022 may represent selected content to be inserted into stream 1002. In some embodiments, segment 1022 may represent a commercial transmitted during a past live event (e.g., Super Bowl) or during a previous airing of a scheduled program (e.g., season finale of “Mad Men” Season 1). In some embodiments, segment 1022 may represent a display screen of a user's personal calendar, task list, or list of reminders.

A user may use an options display screen, such as display screen 600 of FIG. 6A or display screen 620 of FIG. 6B, to select content to insert into a stream of video signals represented by stream 1002. Content selected by a viewer for insertion may be represented by segment 1022, which has the same duration as segment 1010. A user may use an options display screen, such as display screen 640 of FIG. 6C or display screen 700 of FIG. 7, to specify a circumstance under which the selected content should be presented. Control circuitry 304 may receive user selections of displayed options and insert content into streams of video signals at the appropriate time. For example, control circuitry 304 may receive a user selection of a Doritos commercial (option 602 in FIG. 6A) and a user selection to display the selected Doritos commercial during a commercial break (option 704 of FIG. 7). Thus, when control circuitry 304 detects a commercial break (corresponding to the beginning of segment 1010 in stream 1002), control circuitry 304 may generate a display of the selected Doritos commercial instead of the transmitted default commercial. This insertion of the Doritos commercial is illustrated by replacing segment 1010, which represents the default commercial, with segment 1022, which represents the selected Doritos commercial, in stream 1002.

Schematic 1050 of FIG. 10B shows a stream of video signals 1052 resulting from replacing segment 1010 in stream 1002 with segment 1022. Stream 1052 made up of segments 1054, 1056, 1058, 1060, 1062, 1064, 1066, 1068, and 1070. Segments 1054, 1056, 1058, 1060, 1062, 1064, 1066, 1068, and 1070 of FIG. 10B correspond to segments 1004, 1006, 1008, 1022, 1012, 1014, 1016, 1018, and 1020, respectively, of FIG. 10A.

In some embodiments, segment 1060 may represent a display screen of a user's personal calendar, task list, or list of reminders that a user has chosen to display instead of a default commercial. Control circuitry 304 may generate a display of the appropriate display screen for the duration of the default commercial. Thus, the total length of stream 1052 will be the same as the total length of stream 1002.

In some embodiments, segment 1060 may represent a past advertisement inserted in place of a default commercial. In some embodiments, the past advertisement may be identified by control circuitry 304 as having the same duration as the default commercial. For example, control circuitry 304 may receive commercial data packets that include metadata of a default commercial (e.g., a currently transmitted commercial that will be replaced by a past advertisement). Control circuitry 304 may examine the information in the commercial data packets (e.g., metadata of the currently transmitted commercial) to determine the duration of the default commercial. Control circuitry 304 may also determine the duration of the past advertisement by analyzing a corresponding information tag with duration information. The duration information may be obtained, for example, by retrieving information from a duration field of an advertisement information data structure (e.g., duration fields 956 and 964 of advertisement information data structure 950). Control circuitry may then compare the duration of the default commercial with the duration of the past advertisement.

If the past advertisement selected for insertion has the same duration as the default commercial, control circuitry 304 may insert the identified commercial may into a stream of video signals without having to insert any filler or truncate another segment of the stream. If a past advertisement selected to be inserted is shorter than a default commercial, control circuitry 304 may insert a black screen to fill the extra time, or may start the next segment immediately after the past advertisement concludes. This latter approach would result in the total length of stream 1052 being shorter than the total length of stream 1002. It should be understood that any of the steps for inserting an identified commercial into a stream of video signals may be performed by control circuitry 436.

FIG. 11 is an illustrative flow diagram 1100 for presenting an advertisement. The process of FIG. 11 involves receiving a first user input selecting a past media event and searching a server for advertisements transmitted during the selected past media event. Once such an advertisement has been identified, a second user input is received that specifies a circumstance under which the identified advertisement should be presented. A display of the identified advertisement is generated when the circumstance specified by the second user input is met. The steps of flow diagram 1100 may be performed by control circuitry on a user equipment device, such as control circuitry 304. It is contemplated that the steps or descriptions of FIG. 11 may be used with any other embodiment of this disclosure.

At step 1102, a first user input that selects a past media event is received. In some embodiments, a user may use user input interface 310, such as a remote control, to select a past media event. User input interface 310 may transmit the user selection to control circuitry 304 using, for example, an infrared signal. In some embodiments, the selected past media event may be a past live event, and a user may use user interface 310 to select a past live event option from display screen 500. The user may select a displayed option by moving a cursor or highlight region over one of the displayed options and then pressing a designated button on user input device 310 (e.g., “OK” button on a remote control, left button on a computer mouse). Any other suitable means for receiving a user selection of a past live event may be used (e.g., voice recognition software, detecting motions of a user, sensing a user selection on a touch-screen device).

At step 1104, a first query for information corresponding to advertisements transmitted during the selected past media event is transmitted to a server. In some embodiments, control circuitry 304 may establish or activate a communication link with a server, such as advertisement database 428, via communications network 414. In some embodiments, the query may be the name of the selected past media event formatted as a character string, or any other format suitable for alpha-numeric characters. Control circuitry 304 may transmit the query over a communication path, such as communication path 432, to the server. The query may be received by control circuitry of the server, such as control circuitry 436 of advertisement database 428.

At step 1106, data corresponding to an advertisement identified to have been transmitted during the selected past media event is received from the server. In some embodiment, the data may be in the form of one or more data packets. In some embodiments, the data may be transmitted by control circuitry of the server, such as control circuitry 436 of advertisement database 428, over communication path 432 over communications network 414 to a user equipment device. Control circuitry 304 of the user equipment device may receive and read the data transmitted from the server. In some embodiments, the data may include information corresponding to a plurality of advertisements each having an information tag that matches the selected past media event. In some embodiments, control circuitry 304 may use the information in the received data to generate display screen 600.

In some embodiments, the data may include a name and/or sponsor of an advertisement transmitted during the selected past media event. In some embodiments, data packet(s) may be generated by control circuitry of the server, such as control circuitry 436 of advertisement database 428, after control circuitry of the server filters information tags corresponding to advertisements stored on the server for tags that match the selected past media event. For example, control circuitry 436 may search when_transmitted fields of data structure 950 for information that matches the name of the selected past media event. When a matching when_transmitted field is found, control circuitry 436 may retrieve information in the name and/or sponsor field for the corresponding advertisement for inclusion in the data packet.

In some embodiments, the data may include information corresponding to an advertisement that has been identified by control circuitry 436 based on a targeted advertising scheme. To identify an advertisement based on a targeted advertising scheme, control circuitry may analyze a user profile (e.g., a user profile received from viewer profile database 430 or user equipment device 402, 404, or 406) to determine types of products or services the user likes.

In some embodiments, control circuitry 436 may create a list of past advertisements that were transmitted during the user-selected past media event and that promote products or services of interest to the user. Control circuitry 436 may select from the list an advertisement that has a high probability of being of interest to the user. In some embodiments, the probability may be an affinity metric calculated by control circuitry 436. In some embodiments, control circuitry 436 may select from the list an advertisement that the user has not seen before. Control circuitry 436 may determine whether the user has seen an advertisement before by examining the user's viewing history, which may be part of a user profile stored in viewer profile database 430 or locally in a memory of a user equipment device. Control circuitry 436 may include in the data packet information corresponding to the selected advertisement.

At step 1108, a second user input is received that specifies a circumstance under which the identified advertisement should be presented. In some embodiments, a user may use user input interface 310, such as a remote control, to select a circumstance under which the identified advertisement should be presented. User input interface 310 may transmit the user selection to control circuitry 304 using, for example, an infrared signal. In some embodiments, a user may use user interface 310 to select a circumstance option from display screen 700. The user may select a displayed option by moving a cursor or highlight region over one of the displayed options and then pressing a designated button on user input device 310 (e.g., “OK” button on a remote control, left button on a computer mouse). Any other suitable means for receiving a user selection of a past live event may be used (e.g., voice recognition software, detecting motions of a user, sensing a user selection on a touch-screen device).

At step 1110, a display of the identified advertisement is generated when the circumstance specified by the second user input received at step 1108 is met. In some embodiments, control circuitry 304 may insert the identified advertisement into a stream of video signals when the circumstance specified by the second user input is met, as discussed above with respect to FIGS. 10A and 10B. In some embodiments, control circuitry 304 may detect when the specified circumstance is met. For example, if the specified circumstance is a commercial break, control circuitry 304 may analyze metadata received with a stream of video signals to determine the nature of the content in the stream. Control circuitry 304 may detect a commercial break by determining that metadata associated with a currently displayed video signal has changed from describing a scheduled program to describing an advertisement.

FIG. 12A is an illustrative flow diagram 1200 for searching a program guide database for past live events. The process of FIG. 12A involves accessing a program guide database to search for past programs that were broadcasts of live events. Information found as a result of this search may be used to generate display screen 500 of FIG. 5. It is contemplated that the steps or descriptions of FIG. 12A may be used with any other embodiment of this disclosure.

At step 1202, a program guide database is accessed. In some embodiments, the accessed program guide database may be media guidance data source 418. In some embodiments, control circuitry 304 may establish or activate a communication link with media guidance data source 418 via communications network 414. In some embodiments, control circuitry 304 may transmit a query for past broadcasts of live events to the accessed program guide database, such as media guidance data source 418. Control circuitry 304 may transmit the query over communication path 422 to media guidance data source 418. The query may be received by control circuitry 426 of media guidance data source 418.

At step 1204, a past program in the program guide database accessed at step 1202 is selected. In some embodiments, the past program may be selected by control circuitry of the program guide database, such as control circuitry 426 of media guidance data source 418, based on a counter value, as discussed further with respect to FIG. 12B.

At step 1206, it is determined whether the selected past program is tagged as a broadcast of a live event. In some embodiments, control circuitry 426 may make the determination at step 1206 by examining metadata or information tags stored with program information in media guidance data source 418. In some embodiments, program information stored in media guidance data source 418 may be stored in a data structure (e.g., similar to advertisement information data structure 950) from which information about the content of a program can be retrieved. If it is determined that the past program selected at step 1204 was a broadcast of a live event, the process proceeds to step 1208 before proceeding to step 1210. If it is determined that the past program selected at step 1204 was not a broadcast of a live event, the process proceeds directly to step 1210.

At step 1208, the name of the live event is added to a list of past live events. In some embodiments, control circuitry 426 may retrieve the name of the live event from an event name field of a program information data structure stored in media guidance data source 418. Control circuitry 426 may add the name to a list of past live events, which may be stored in RAM on the media guidance data source 418. The list of past live events may be used to accumulate names of past live events identified during the process of searching a program guide database for past broadcasts of live events. After a name is added to the list of past live events, the process proceeds to step 1210.

At step 1210, it is determined whether there are more past programs in the database that have not yet been examined. In some embodiments, control circuitry 426 may make the determination at step 1210. For example, control circuitry 426 may compare a current counter value with a maximum counter value equal to the number of entries in a program information data structure, as further discussed below with respect to FIG. 12B. Control circuitry 426 may determine that there are more unexamined past programs in the database if the current counter value is less than the maximum counter value. Control circuitry 426 may determine that all past programs in the database have been examined if the current counter value is equal to the maximum counter value. If it is determined at step 1210 that there are more past programs in the database to examine, the process proceeds to step 1212. If it is determined at step 1210 that there are no more past programs in the database to examine, the process proceeds to step 1214.

At step 1212, another past program is selected from the program guide database accessed at step 1202. In some embodiments, control circuitry 426 may select another past program by incrementing a counter value and selecting a past program based on the incremented counter value, as discussed with respect to FIG. 12B. The process then loops back to step 1206.

At step 1214, the list of past live events accumulated at step 1208 is returned. In some embodiments, control circuitry 426 may transmit the list of past live events in one or more data packets over communications path 422 to a user equipment device. In some embodiments, the list of past live events may be received by control circuitry 304 and displayed on display 312 of user equipment device 300. For example, control circuitry 304 may use the received list of past live events to generate display screen 500.

FIG. 12B is an illustrative flow diagram 1250 for searching a program guide database for past live events. The process of FIG. 12B involves searching a program guide database for past programs that were broadcasts of live events. In some embodiments, information about past programs may be stored in a program information data structure similar to advertisement information data structure 950. The program information data structure may include data fields, such as “event” fields with information about the names of events that are the subjects of programs. A field corresponding to a particular program may be referred to as an “information tag.” The steps of flow diagram 1250 may be performed by control circuitry of a program guide database, such as control circuitry 426 of media guidance data source 418, or any other suitable control circuitry. It is contemplated that the steps or descriptions of FIG. 12B may be used with any other embodiment of this disclosure.

At step 1252, a past live events list is initialized. In some embodiments, control circuitry 426 may initialize the past live events list by creating an empty list or an empty matrix. At step 1254, a counter is initialized. The counter will be used to track the progression of process 1250 through an array of data fields such as those found in a program information data structure. In some embodiments, control circuitry 426 may initialize the counter by assigning a value of zero to the counter.

At step 1256, a past program in the program guide database is retrieved based on the counter value. In some embodiments, control circuitry 426 may retrieve, from a program information data structure, a program field at an index number equal to the counter value, the program field corresponding to a past program in the program guide database. At step 1258, an event information tag of the past program is retrieved. In some embodiments, control circuitry 426 may retrieve information in an event field corresponding to the past program of step 1256.

At step 1260, it is determined whether the event information tag retrieved at step 1258 has the name of a past live event. In some embodiments, control circuitry 426 may analyze the information in the event field of step 1260 to determine whether the information includes the word “live.” In some embodiments, program information data structure may include a separate data field for each program that indicates whether or not the program is a broadcast of a live event. If such a field exists, it may be retrieved by control circuitry 426 to make the determination at step 1260. If it is determined at step 1260 that the event information tag does has the name of a past live event, the process proceeds to step 1262 before proceeding to step 1264. If it is determined at step 1260 that the event information tag does not have the name of a past live event, the process proceeds directly to step 1264.

At step 1262, the name of the past live event corresponding to the event information tag of step 1260 is added to the past live events list. In some embodiments, if the past live events list is formatted as a list, control circuitry 426 may concatenate a string of the name of the past live event to the list. If the past live events list is formatted as a matrix, control circuitry 426 may add a row to the matrix with the name of the past live event.

At step 1264, it is determined whether the current value of the counter is equal to the maximum value of the counter. In some embodiments, the maximum value of the counter may be one more than the highest index number of the program information data structure. Control circuitry 426 may have a comparator for comparing the current value of the counter and the maximum value of the counter. If the current value of the counter is not equal to the maximum value, the process proceeds to step 1266, at which point the counter is incremented before the process returns to step 1256. If the current value of the counter is equal to the maximum value, the process proceeds to step 1268.

At step 1268, it is determined whether the past live events list is a null list. In some embodiments, control circuitry 426 may determine if the list or matrix containing the past live events list is empty (i.e., null). If it is determined at step 1268 that the past live events list is a null list, the process proceeds to step 1270, at which point the string “NO PAST LIVE EVENTS FOUND” is returned. In some embodiments, control circuitry 426 may transmit the string “NO PAST LIVE EVENTS FOUND” or similar information indicating that the program guide database did not have information for any past live events. If it is determined at step 1268 that the past live events list is not a null list, the process proceeds to step 1272, at which point the past live events list is returned. In some embodiments, control circuitry 426 may transmit the past live events list in one or more data packets over communications path 422 to a user equipment device. In some embodiments, the past live events list may be received by control circuitry 304 and displayed on display 312 of user equipment device 300. For example, control circuitry 304 may use the received list of past live events to generate display screen 500.

FIG. 13A is an illustrative flow diagram 1300 for searching an advertisement database for advertisements from a past live event. The process of FIG. 13A involves accessing an advertisement database to search for past advertisements that were transmitted during a selected past live event, such as a past live event selected from display screen 500. Information found as a result of this search may be used to generate display screen 600 of FIG. 6A. It is contemplated that the steps or descriptions of FIG. 13A may be used with any other embodiment of this disclosure.

At step 1302, an advertisement database is accessed. In some embodiments, the accessed advertisement database may be advertisement database 428. A user equipment device, such as any of user equipment devices 402, 404, and 406, may access advertisement database 428 via communications path 432. In some embodiments, control circuitry 304 may establish or activate a communication link with advertisement database 428 via communications network 414.

At step 1304, the name of a selected past live event may be transmitted to the advertisement database accessed at step 1302. The past live event may be selected from display screen 500. In some embodiments, control circuitry 304 may transmit the name of the selected past live event over communications path 432 as part of a query to advertisement database 428 for past advertisements transmitted during the past live event. The query may be received by control circuitry 436 of advertisement database 428.

At step 1306, an advertisement in the database accessed at step 1302 is selected. In some embodiments, the advertisement may be selected by control circuitry of the advertisement database, such as control circuitry 436 of advertisement database 428, based on a counter value, as discussed further with respect to FIG. 13B.

At step 1308, information tags of the selected advertisement selected are retrieved. In some embodiments, the information tags may be retrieved by control circuitry 436 from a data structure such as advertisement information data structure 950. In some embodiments, control circuitry 436 may retrieve information in a when_transmitted field corresponding to the selected advertisement in advertisement information data structure 950.

At step 1310, an information tag retrieved at step 1308 is compared with the name of the selected past live event. In some embodiments, the comparison may be performed by control circuitry 436 using a fuzzy text matching algorithm, as discussed above with respect to FIG. 9B. For example, control circuitry 436 may perform a character-by-character comparison of a string corresponding to the name of the selected past live event and a string of information in a when_transmitted field.

At step 1312, it is determined whether the information tag compared at step 1310 matches the name of the selected past live event transmitted at step 1304. In some embodiments, the determination at step 1312 may be performed by control circuitry 436. For example, control circuitry 436 may determine that a when_transmitted field information string matches the selected past live event string if a certain percentage (e.g., 85% or more) of the characters are identical. If it is determined that the information tag does not match the name of the selected past live event, the process proceeds to step 1314. If it is determined that the information tag matches the name of the selected past live event, the process proceeds to step 1316.

At step 1314, it is determined whether more information tags exist for the selected advertisement. In some embodiments, the determination at step 1314 may be performed by control circuitry 436. For example, control circuitry 436 may determine whether a when_transmitted field of data structure 950 includes more than one media event name, and if so, whether all the media event names have been compared to the name of the selected past live event. If it is determined that more information tags for the selected advertisement exist, the process proceeds to step 1318. If it is determined that no more information tags for the selected advertisement exist (i.e., that all information tags for the selected advertisement have been examined and found not to match the name of the selected past live event), the process proceeds to step 1320.

At step 1316, the selected advertisement is added to a list of advertisements transmitted during the selected past live event. In some embodiments, control circuitry 436 may retrieve the name of the selected advertisement from an advertisement name field (e.g., field 952 or 960) of advertisement information data structure 950 stored in advertisement database 428. In some embodiments, control circuitry 436 may retrieve the sponsor of the selected advertisement from a sponsor field (e.g., field 954 or 962) of advertisement information data structure 950 stored in advertisement database 428. Control circuitry 436 may add the retrieved advertisement name or sponsor to a list of advertisements transmitted during the selected past live event. The list may be stored in RAM on the advertisement database 428 and used to accumulate names of advertisements identified during the process of searching an advertisement database for advertisements transmitted during the selected past live event. After an advertisement name or sponsor is added to the list of advertisements transmitted during the selected past live event, the process proceeds to step 1320.

At step 1318, a next retrieved information tag for the selected advertisement is compared with the name of the selected past live event. In some embodiments, the comparison at step 1318 may be performed by control circuitry 436. For example, if a when_transmitted field of data structure 950 includes more than one media event name and not all the media event names have been compared to the name of the selected past live event, control circuitry 436 may retrieve an unexamined media event name (e.g., the next media event name after the media event name that was just compared) from the when_transmitted field for comparison with the name of the selected past live event. The process then loops back to step 1312.

At step 1320, it is determined whether there are more advertisements in the database that have not yet been examined. In some embodiments, the determination at step 1320 may be performed by control circuitry 436. For example, control circuitry 436 may compare a current counter value with a maximum counter value equal to the number of entries in an advertisement information data structure, as further discussed below with respect to FIG. 13B. Control circuitry 436 may determine that there are more unexamined advertisements in the database if the current counter value is less than the maximum counter value. Control circuitry 436 may determine that all advertisements in the database have been examined if the current counter value is equal to the maximum counter value. If it is determined that there are more advertisements to examine, the process proceeds to step 1322. If it is determined that there are no more advertisements to examine (i.e., that all advertisements in the accessed advertisement database have been examined to determine whether they were transmitted during the selected past live event), the process proceeds to step 1324.

At step 1322, a next advertisement in the accessed advertisement database is selected. In some embodiments, control circuitry 436 may select the next advertisement by incrementing a counter value and selecting an advertisement based on the incremented counter value, as discussed with respect to FIG. 13B. The process then loops back to step 1308.

At step 1324, a list of advertisements transmitted during the selected past live event is returned. In some embodiments, control circuitry 436 may transmit the list of advertisements in one or more data packets over communications path 432 to one of user equipment devices 402, 404, and 406. In some embodiments, the list of advertisements may be received by control circuitry 304 and displayed on display 312 of user equipment device 300. For example, control circuitry 304 may use the received list of advertisements to generate display screen 600.

FIG. 13B is an illustrative flow diagram 1350 for searching an advertisement database for advertisements from a past live event. The process of FIG. 13B involves searching an advertisement information data structure, such as advertisement information data structure 950, for past advertisements that were transmitted during a selected past live event, such as a past live event selected from display screen 500. Information found as a result of this search may be used to generate display screen 600 of FIG. 6A. The steps of flow diagram 1350 may be performed by control circuitry of an advertisement database, such as control circuitry 436 of advertisement database 428, or any other suitable control circuitry. It is contemplated that the steps or descriptions of FIG. 13B may be used with any other embodiment of this disclosure.

At step 1352, a list of advertisements transmitted during a selected past live event is initialized. In some embodiments, control circuitry 436 may initialize the list of advertisements by creating an empty list or an empty matrix. At step 1354, an advertisement counter (ad_counter) is initialized. The ad_counter will be used to track the progression of process 1350 through an array of data fields such as those found in advertisement information data structure 950. In some embodiments, control circuitry 436 may initialize ad_counter by assigning it a value of zero. At step 1356, an information tag counter (tag_counter) is initialized. The tag_counter will be used to track the progression of process 1350 through a when_transmitted field of advertisement information data structure 950. In some embodiments, control circuitry 436 may initialize tag_counter by assigning it a value of zero. At step 1358, a maximum tag counter (max_tag_counter) is initialized. The max_tag_counter will be used to determine when to move on to another advertisement. In some embodiments, control circuitry 436 may initialize max_tag_counter by assigning it a value of zero.

At step 1360, an advertisement in the database is retrieved based on the value of ad_counter. In some embodiments, control circuitry 436 may retrieve, from an advertisement information data structure, an advertisement field at an index number equal to the value of ad_counter, the advertisement field corresponding to an advertisement in the advertisement database. At step 1362, information in a when_transmitted field corresponding to the advertisement is retrieved. In some embodiments, control circuitry 436 may retrieve from advertisement information data structure 950 the information in a when_transmitted field corresponding to advertisement of step 1360.

At step 1364, the number of entries in the when_transmitted field are counted. In some embodiments, control circuitry 436 may count the number of media event names in the when_transmitted field by identifying data separators (e.g., commas, periods, slashes, carriage returns) in the field information. At step 1366, max_tag_counter is set equal to the number of entries in the when_transmitted field. In some embodiments, control circuitry 436 may assign the number determined at step 1364 to max_tag_counter.

At step 1368, an entry of the when_transmitted field is retrieved based on the value of tag_counter. In some embodiments, the retrieved when_transmitted field may include names of multiple media event names, each of which may be assigned an index number. Control circuitry 436 may retrieve, from the when_transmitted field, a media event name at an index number equal to the value of tag_counter. At step 1370, it is determined whether the entry retrieved at step 1368 is equal to the name of the selected past live event. In some embodiments, the determination at step 1370 may be performed by control circuitry 436. For example, control circuitry 436 may determine that a string of the retrieved media event name matches the selected past live event string if a certain percentage (e.g., 85% or more) of the characters are identical. If it is determined that the entry retrieved at step 1368 matches the name of the selected past live event, the process proceeds to step 1372.

At step 1372, information in an advertisement name field corresponding to the advertisement retrieved at step 1360 is retrieved. In some embodiments, control circuitry 436 may retrieve the name of the selected advertisement from an advertisement name field (e.g., field 952 or 960) of advertisement information data structure 950 stored in advertisement database 428. In some embodiments, control circuitry 436 may retrieve the sponsor of the selected advertisement from a sponsor field (e.g., field 954 or 962) of advertisement information data structure 950 stored in advertisement database 428. The process then proceeds to step 1374.

At step 1374, the advertisement name is added to the list of advertisements transmitted during the selected past live event. In some embodiments, control circuitry 436 may add the advertisement name (or sponsor name) retrieved at step 1372 to a list of advertisements transmitted during the selected past live event. The list may be stored in RAM on the advertisement database 428 and used to accumulate names of advertisements identified during the process of searching an advertisement database for advertisements transmitted during the selected past live event. After an advertisement name (or sponsor name) is added to the list of advertisements transmitted during the selected past live event, the process proceeds to step 1380.

If it is determined at step 1370 that the entry retrieved at step 1368 does not match the name of the selected past live event, the process proceeds to step 1376, at which point the tag_counter is incremented before the process proceeds to step 1378. At step 1378, it is determined whether the value of tag_counter is equal to the value of max_tag_counter. In some embodiments, control circuitry 436 may have a comparator for comparing the value of tag_counter and the value of max_tag_counter. If it is determined that the value of tag_counter is not equal to the value of max_tag_counter, the process loops back to step 1368. If it is determined that the value of tag_counter is equal to the value of max_tag_counter, the process proceeds to step 1380.

At step 1380, it is determined whether the value of ad_counter is equal to the maximum value of ad_counter. In some embodiments, the maximum value of ad_counter may be one more than the highest index number of the advertisement information data structure. Control circuitry 436 may have a comparator for comparing the current value of ad_counter and the maximum value of ad_counter. If the current value of ad_counter is not equal to the maximum value, the process proceeds to step 1382, at which point ad_counter is incremented. The process then proceeds to step 1384, at which point tag_counter is reset (e.g., to the value it was assigned when initialized), and step 1386, at which point max_tag_counter is reset (e.g., to the value it was assigned when initialized), before the process loops back to step 1360. If the current value of ad_counter is equal to the maximum value, the process proceeds to step 1388.

At step 1388, it is determined whether the list of advertisements transmitted during the selected past live event is a null list. In some embodiments, control circuitry 436 may determine if the list or matrix containing the list of advertisements is empty (i.e., null). If it is determined at step 1388 that the list of advertisements is a null list, the process proceeds to step 1390, at which point the string “NO ADVERTISEMENTS FOUND” is returned. In some embodiments, control circuitry 436 may transmit the string “NO ADVERTISEMENTS FOUND” or similar information indicating that the advertisement database did not have information corresponding to any advertisements transmitted during the selected past live event. If it is determined at step 1388 that the list of advertisements is not a null list, the process proceeds to step 1392, at which point the list of advertisements is returned. In some embodiments, control circuitry 436 may transmit the list of advertisements in one or more data packets over communications path 432 to a user equipment device. In some embodiments, the list of advertisements may be received by control circuitry 304 and displayed on display 312 of user equipment device 300. For example, control circuitry 304 may use the received list of past live events to generate display screen 600.

In some embodiments, data corresponding to various advertisements is stored on a server in clusters according to when advertisements were transmitted. Information corresponding to advertisements that were transmitted during the same broadcast of a live event may be stored in consecutive entries in an advertisement information data structure, such as advertisement information data structure 950. Thus, a process for searching an advertisement database for advertisements transmitted during a particular past live event, such as the processes illustrated in FIGS. 13A and 13B, may be streamlined because control circuitry 436 may only have to search in the vicinity of a data cluster corresponding to a selected past live event. Thus, not all advertisements in the advertisement database must be examined.

For example, after a first entry corresponding to an advertisement transmitted during a selected past live event is identified in an advertisement information data structure, several consecutive subsequent entries in the data structure are likely to correspond to other advertisements transmitted during the same past live event. Thus, after determining that a series of consecutive database entries all correspond to advertisements transmitted during the selected past live event, control circuitry 436 may conclude that the end of the cluster corresponding to the selected past live event has been reached upon a determination that the currently examined entry does not correspond to an advertisement transmitted during the selected past live event. Control circuitry 436 may then terminate its search and return a list of advertisements transmitted during the selected past live event. In some embodiments, to account for small gaps in the clustered data, control circuitry 436 may not assume that it has reached the end of a data cluster until a certain number of consecutive non-matching entries are determined. For example, control circuitry 436 may not terminate its search until determining that information in five consecutive database entries do not correspond to advertisements transmitted during a selected past live event.

FIG. 14 is an illustrative flow diagram 1400 for displaying selected content during a selected program. The process of FIG. 14 involves receiving a user selection of a program during which selected content, such as a past advertisement or a user's personal calendar, should be presented. When a commercial break of the selected program is detected, a display of the selected content is generated. The steps of flow diagram 1400 may be performed by control circuitry 304 of a user equipment device, or any other suitable control circuitry. It is contemplated that the steps or descriptions of FIG. 14 may be used with any other embodiment of this disclosure.

At step 1402, a display of a program guide is generated. In some embodiments, the display may be generated by control circuitry 304 after a user selects content to be inserted into a stream of video signals. In some embodiments, control circuitry 304 may generate the display after a user specifies a commercial break as a circumstance under which selected content should be presented (e.g., after a user selects option 704 or 706 from display screen 700). The displayed program guide may be one of media guidance data display screens 100 and 200, or any other suitable display screen for presenting program options to a user.

At step 1404, a user selection is received of a program listing in the displayed program guide. In some embodiments, a user may use user input interface 310, such as a remote control, to select a program listing from media guidance display screen 100 or 200. User input interface 310 may transmit the user selection to control circuitry 304 using, for example, an infrared signal. The user may select a program listing by moving a cursor or highlight region over one of the displayed listings and then pressing a designated button on user input device 310 (e.g., “OK” button on a remote control, left button on a computer mouse). Any other suitable means for receiving a user selection of a program listing may be used (e.g., voice recognition software, detecting motions of a user, sensing a user selection on a touch-screen device). The selected program listing may correspond to a scheduled program that will be transmitted in the future.

At step 1406, a program guide database is accessed to determine a time period during which a scheduled program corresponding to the program listing selected at step 1404 will be transmitted. In some embodiments, the accessed program guide database may be media guidance data source 418, which may be accessed via communications path 422. In some embodiments, control circuitry 304 may establish or activate a communication link with media guidance data source 418 via communications network 414. In some embodiments, control circuitry 304 may transmit a query to the accessed program guide database for the time period of the scheduled program corresponding to the selected program listing. Control circuitry 304 may transmit the query over communication path 422 to media guidance data source 418. The query may be received by control circuitry 426 of media guidance data source 418. Control circuitry 426 may retrieve the time period information from a program information data structure stored on media guidance data source 418, then transmit the time period information in a data packet to control circuitry 304.

At step 1408, the current time is compared to the time period determined at step 1406. In some embodiments, the comparison at step 1408 may be performed by control circuitry 304. Control circuitry 304 may maintain a clock in user equipment device 300 that keeps track of the current time. Control circuitry 304 may have a comparator for comparing the current time with the start and end times of the time period determined at step 1406. It should be understood that the comparison at step 1408 may be performed by any other suitable control circuitry, such as control circuitry 426 of media guidance data source 418.

At step 1410, it is determined whether the current time is during the time period determined at step 1406. In some embodiments, the determination at step 1410 is performed by control circuitry 304. Control circuitry 304 may determine that the current time is during the time period determined at step 1406 if the current time is equal to or greater than start time of the program time period and less than the end time of the program time period. It should be understood that the determination at step 1410 may be performed by any other suitable control circuitry, such as control circuitry 426 of media guidance data source 418. If it is determined that the current time is not during the determined time period, the process loops back to step 1408. If it is determined that the current time is during the determined time period, the process proceeds to step 1412.

At step 1412, it is determined whether a commercial break has been detected. In some embodiments, the determination at step 1412 may be performed by control circuitry 304. For example, control circuitry 304 may examine the metadata transmitted with a stream of currently received video signals to determine whether the video signals are of a commercial nature. If a commercial break has not been detected at step 1412, the process proceeds to step 1414, at which point a display of the scheduled program selected at step 1404 continues to be generated. In some embodiments, the display at step 1414 may be generated by control circuitry 304. The process then loops back to step 1412.

If a commercial break has been detected at step 1412, the process proceeds to step 1416. At step 1416, a display of the selected content is generated. In some embodiments, the display at step 1416 may be generated by control circuitry 304. In some embodiments, control circuitry 304 may generate an instruction to insert the selected content (e.g., a past advertisement, a user's personal calendar, a user's personal task list, or a user's list of reminders) into a stream of video signals, which may then be displayed on display 312 of user equipment device 300.

FIG. 15A is an illustrative flow diagram 1500 for replacing all default commercials of a commercial break with past advertisements. The process of FIG. 15A involves detecting a commercial break in a currently viewed program and calculating the duration of the detected commercial break. A plurality of advertisements transmitted during a selected live event can then be identified whose aggregate duration is equal to the calculated duration of the commercial break. The identified plurality of advertisements may then be displayed during the commercial break instead of the currently transmitted commercials (i.e., default commercials). The steps of flow diagram 1500 may be performed after a user selects option 706 of display screen 700. It is contemplated that the steps or descriptions of FIG. 15A may be used with any other embodiment of this disclosure (e.g., embodiments where a user's calendar, task list, or reminders are displayed for the duration of a commercial break).

At step 1502, a commercial break in a currently viewed program is detected. In some embodiments, control circuitry 304 may examine the metadata transmitted with a stream of currently received video signals to determine the nature of the content in the stream. Control circuitry 304 may detect a commercial break by determining that metadata associated with a currently displayed video signal has changed from describing a scheduled program to describing an advertisement.

At step 1504, the duration of the commercial break detected at step 1502 is calculated. In some embodiments, control circuitry 304 may calculate the duration of the commercial break. For example, control circuitry 304 may receive commercial data packets that include metadata of default commercials of a commercial break. Control circuitry 304 may examine the information in the commercial data packets to determine the duration of each default commercial to be transmitted during the commercial break. Control circuitry 304 may then add up the durations of the default commercials to determine the total duration of the commercial break.

At step 1506, a plurality of advertisements are identified that were transmitted during a selected live event and whose aggregate duration is equal to the duration of the detected commercial break calculated at step 1504. Advertisements transmitted during a selected live event may be identified using one of the processes illustrated in FIGS. 13A and 13B, or any other suitable process. In some embodiments, control circuitry 304 may query a server, such as advertisement database 428, for the duration of each identified advertisement. Control circuitry 436 of advertisement database 428 may retrieve, for each identified advertisement, information from a corresponding duration field of an advertisement information data structure (e.g., duration fields 956 and 964 of advertisement information data structure 950). Control circuitry 436 may select a combination of identified advertisements whose combined duration is equal to the duration of the detected commercial break. In some embodiments, the selection of the combination may be based on a targeted advertising scheme, as discussed above with respect to FIGS. 6A and 7. Control circuitry 436 may transmit information corresponding to the selected combination of advertisements in a plurality of data packets that are received by control circuitry 304. It should be understood that the steps of selecting a combination of advertisements whose aggregate duration is equal to the duration of the detected commercial break may be performed by control circuitry 304.

At step 1508, a display is generated of the plurality of advertisements identified at step 1506 instead of currently transmitted commercials during the commercial break detected at step 1502. In some embodiments, control circuitry 304 may generate an instruction to insert the plurality of advertisements into a stream of video signals. The selected plurality of advertisements may thus be displayed instead of the default commercials on display 312 of user equipment device 300 during a commercial break of the currently viewed program.

FIG. 15B is an illustrative flow diagram 1550 for displaying reminders during a commercial break. The process of FIG. 15B involves detecting a commercial break in a currently viewed program and calculating the duration of the detected commercial break. A time when the currently transmitted commercial will end is calculated, and a display of reminders is generated if the current time is before the end time of the currently transmitted commercial. Therefore, reminders are presented to the user instead of the currently transmitted commercial. When the currently transmitted commercial ends, a display is generated from a received stream of video signals such that the display of scheduled programming or commercials resumes. The steps of flow diagram 1550 may be performed after a user selects option 646 of display screen 640. It is contemplated that the steps or descriptions of FIG. 15B may be used with any other embodiment of this disclosure.

At step 1552, a commercial break in a currently viewed program is detected. In some embodiments, control circuitry 304 may examine the metadata transmitted with a stream of currently received video signals to determine the nature of the content in the stream. Control circuitry 304 may detect a commercial break by determining that metadata associated with a currently displayed video signal has changed from describing a scheduled program to describing an advertisement.

At step 1554, the duration of the currently transmitted commercial is calculated. In some embodiments, control circuitry 304 may calculate the duration of the currently transmitted commercial. For example, control circuitry 304 may receive commercial data packets that include metadata of the currently transmitted commercial. Control circuitry 304 may examine the information in the commercial data packets to determine the duration of the currently transmitted commercial.

At step 1556, the time when the currently transmitted commercial will end is determined. In some embodiments, control circuitry 304 may calculate the end time of the currently transmitted commercial. For example, control circuitry 304 may determine the start time of the currently transmitted commercial and add the duration of the currently transmitted commercial calculated at step 1554.

At step 1558, the current time is compared to the end time of the currently transmitted commercial determined at step 1556. In some embodiments, the comparison at step 1558 may be performed by control circuitry 304. Control circuitry 304 may maintain a clock in user equipment device 300 that keeps track of the current time. Control circuitry 304 may have a comparator for comparing the current time with the end time of the currently transmitted commercial determined at step 1556. It should be understood that the comparison at step 1558 may be performed by any other suitable control circuitry, such as control circuitry 426 of media guidance data source 418.

At step 1560, it is determined whether the current time is before the end time of the currently transmitted commercial determined at step 1556. In some embodiments, the determination at step 1560 is performed by control circuitry 304. Control circuitry 304 may determine that the current time is before the end time determined at step 1556 if the current time is less than the end time of the currently transmitted commercial. It should be understood that the determination at step 1560 may be performed by any other suitable control circuitry, such as control circuitry 426 of media guidance data source 418. If it is determined that the current time is before the determined end time, the process proceeds to step 1562. If it is determined that the current time is not before the determined end time, then the currently transmitted commercial has ended and the process proceeds to step 1564.

At step 1562, a display of reminders is generated. In some embodiments, the display at step 1562 may be generated by control circuitry 304. In some embodiments, control circuitry 304 may generate an instruction to insert a display of reminders into a stream of video signals, which may then be displayed on display 312 of user equipment device 300. The displayed reminders may include a user's personal reminders, such as reminders to watch certain programs (e.g., a sports game or movie), a reminder of an upcoming appointment (e.g., doctor's appointment) for the user, a reminder for a task the user needs to perform (e.g., take a cake out of the oven), any other type of reminder, or any combination thereof. In some embodiments, the displayed reminders may include items from the user's personal task list. The process then loops back to step 1558.

At step 1564, a display is generated from a received stream of video signals. The display of scheduled programming or commercials may thus resume. In some embodiments, the display at step 1564 may be generated by control circuitry 304.

It should be understood that the above steps of the flow diagrams of FIGS. 11-15B may be executed or performed in any order or sequence not limited to the order and sequence shown and described in each figure. Also, some of the above steps of the flow diagrams of FIGS. 11-15B may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for presenting an advertisement, the method comprising:
receiving a first user input selecting a past media event;
transmitting, to a server, a first query for information corresponding to advertisements transmitted during the selected past media event;
receiving, from the server, data corresponding to an advertisement identified to have been transmitted during the selected past media event;
receiving a second user input specifying a circumstance under which the identified advertisement from the past media event should be presented; and
generating for display, the identified advertisement when the circumstance specified by the second user input is met.

2. The method of claim 1, wherein the circumstance specified by the second user input is a commercial break of a program, the method further comprising:
accessing a program guide database to determine a time period during which a selected program will be transmitted;
comparing a current time to the determined time period; and
when the current time is during the determined time period, determining whether a commercial break has been detected, wherein the display of the identified advertisement is generated when a commercial break is detected.

3. The method of claim 2, wherein determining whether a commercial break has been detected comprises examining metadata transmitted with a stream of currently received video signals to determine whether the video signals are of a commercial nature.

4. The method of claim 1, wherein the specified circumstance is a commercial break in a currently viewed program, the method further comprising:
detecting a commercial break in the currently viewed program; and
replacing a currently transmitted commercial of the commercial break with the identified advertisement.

5. The method of claim 4, further comprising:
receiving metadata of the replaced currently transmitted commercial; and
examining metadata of the currently transmitted commercial to determine its duration, wherein the identified advertisement has the same duration as the replaced currently transmitted commercial.

6. The method of claim 4, further comprising:
calculating a duration of the detected commercial break;
receiving, from the server, information corresponding to a plurality of advertisements identified as having been transmitted during the selected past media event and whose aggregate duration is equal to the calculated duration of the detected commercial break; and
generating for display, the identified plurality of advertisements instead of currently transmitted commercials during the detected commercial break.

7. The method of claim 1, wherein:
a database of previously transmitted advertisements is stored on the server;
information tags corresponding to advertisements stored on the server are filtered for tags that match the selected past media event; and
the received data comprises information corresponding to a plurality of advertisements each having an information tag that matches the selected past media event.

8. The method of claim 7, further comprising:
generating for display representations of the plurality of advertisements having tags that match the selected past media event; and
receiving a user selection of one of the displayed representations.

9. The method of claim 1, further comprising:
accessing a program guide database;
transmitting, to the program guide database, a second query for past broadcasts of live events;
receiving, from the program guide database, a list of past live events that were broadcast in the past; and
generating for display, the list of past live events, wherein the selected past media event is a past live event selected from the generated display of the list of past live events.

10. The method of claim 1, further comprising generating for display selectable options for the circumstance under which the identified advertisement should be presented, wherein the options comprise:
i) generating for display, the identified advertisement immediately, and
ii) generating for display, the identified advertisement during a commercial break of a program.

11. The method of claim 1, further comprising:
generating for display, a program guide;
receiving a user selection of a program listing in the displayed program guide, wherein the specified circumstance of the received second user input is a commercial break of a scheduled program corresponding to the selected program listing; and
accessing a program guide database to determine a time period during which the scheduled program corresponding to the selected program listing will be transmitted, wherein the display of the identified advertisement is generated when a commercial break is detected during the determined time period.

12. The method of claim 1, further comprising inserting the identified advertisement into a stream of video signals to be generated for display on a user device.

13. A system for presenting an advertisement, the system comprising control circuitry configured to:
receive a first user input selecting a past media event;
transmit, to a server, a first query for information corresponding to advertisements transmitted during the selected past media event;
receive, from the server, data corresponding to an advertisement identified to have been transmitted during the selected past media event;
receive a second user input specifying a circumstance under which the identified advertisement from the past media event should be presented; and
generate for display, the identified advertisement when the circumstance specified by the second user input is met.

14. The system of claim 13, wherein the circumstance specified by the second user input is a commercial break of a program, and wherein the control circuitry is further configured to:
access a program guide database to determine a time period during which a selected program will be transmitted;
compare a current time to the determined time period; and
when the current time is during the determined time period, determine whether a commercial break has been detected, wherein the display of the identified advertisement is generated when a commercial break is detected.

15. The system of claim 14, wherein the control circuitry is further configured to examine metadata transmitted with a stream of currently received video signals to determine whether the video signals are of a commercial nature.

16. The system of claim 13, wherein the specified circumstance is a commercial break in a currently viewed program, and wherein the control circuitry is further configured to:
detect a commercial break in the currently viewed program; and
replace a currently transmitted commercial of the commercial break with the identified advertisement.

17. The system of claim 16, wherein the control circuitry is further configured to:
receive metadata of the replaced currently transmitted commercial; and
examine metadata of the currently transmitted commercial to determine its duration, wherein the identified advertisement has the same duration as the replaced currently transmitted commercial.

18. The system of claim 16, wherein the control circuitry is further configured to:
calculate a duration of the detected commercial break;
receive, from the server, information corresponding to a plurality of advertisements identified as having been transmitted during the selected past media event and whose aggregate duration is equal to the calculated duration of the detected commercial break; and
generate for display, the identified plurality of advertisements instead of currently transmitted commercials during the detected commercial break.

19. The system of claim 13, wherein:
a database of previously transmitted advertisements is stored on the server;
information tags corresponding to advertisements stored on the server are filtered for tags that match the selected past media event; and
the received data comprises information corresponding to a plurality of advertisements each having an information tag that matches the selected past media event.

20. The system of claim 19, wherein the control circuitry is further configured to:
generate for display, representations of the plurality of advertisements having tags that match the selected past media event; and
receive a user selection of one of the displayed representations.

21. The system of claim 13, wherein the control circuitry is further configured to:
access a program guide database;
transmit, to the program guide database, a second query for past broadcasts of live events;
receive, from the program guide database, a list of past live events that were broadcast in the past; and
generate for display, the list of past live events, wherein the selected past media event is a past live event selected from the generated display of the list of past live events.

22. The system of claim 13, wherein the control circuitry is further configured to generate for display, selectable options for the circumstance under which the identified advertisement should be presented, and wherein the options comprise:
i) generating for display, the identified advertisement immediately, and
ii) generating for display, the identified advertisement during a commercial break of a program.

23. The system of claim 13, wherein the control circuitry is further configured to:
generate for display, a program guide;
receive a user selection of a program listing in the displayed program guide, wherein the specified circumstance of the received second user input is a commercial break of a scheduled program corresponding to the selected program listing; and
access a program guide database to determine a time period during which the scheduled program corresponding to the selected program listing will be transmitted, wherein the display of the identified advertisement is generated when a commercial break is detected during the determined time period.

24. The system of claim 13, wherein the control circuitry is further configured to insert the identified advertisement into a stream of video signals to be generated for display on a user device.

25-36. (canceled)

37. A method for presenting an advertisement, the method comprising:
receiving a first query for information corresponding to advertisements transmitted during a selected past media event;
identifying an advertisement that was transmitted during the selected past media event; and
transmitting data corresponding to the identified advertisement to a user equipment device, wherein the identified advertisement is generated for display at the user equipment device when a specified circumstance under which the identified advertisement from the past media event should be presented is met.

38. The method of claim 37, further comprising examining metadata of a currently transmitted commercial to determine its duration, wherein identifying an advertisement comprises identifying an advertisement that has the same duration as the currently transmitted commercial.

39. The method of claim 37, further comprising:
calculating a duration of a commercial break of a program;
identifying a plurality of advertisements that were transmitted during the selected past media event and whose aggregate duration is equal to the calculated duration of the commercial break; and
transmitting, to the user equipment device, information corresponding to the identified plurality of advertisements, wherein a display of the identified plurality of advertisements instead of currently transmitted commercials is generated at the user equipment device during the detected commercial break.

40. The method of claim 37, further comprising:
storing a database of previously transmitted advertisements; and
filtering information tags corresponding to the stored advertisements for tags that match the selected past media event, wherein the transmitted data comprises information corresponding to a plurality of advertisements each having an information tag that matches the selected past media event.

41. The method of claim 37, wherein the advertisement is identified based on a user profile.

42. The method of claim 37, wherein the selected past media event is a past live event.

43. A system for presenting an advertisement, the system comprising control circuitry configured to:
receive a first query for information corresponding to advertisements transmitted during a selected past media event;
identify an advertisement that was transmitted during the selected past media event; and
transmit data corresponding to the identified advertisement to a user equipment device, wherein the identified advertisement is generated for display at the user equipment device when a specified circumstance under which the identified advertisement from the past media event should be presented is met.

44. The system of claim 43, wherein the control circuitry is further configured to:
examine metadata of a currently transmitted commercial to determine its duration; and
identify an advertisement that has the same duration as the currently transmitted commercial.

45. The system of claim 43, wherein the control circuitry is further configured to:
calculate a duration of a commercial break of a program;
identify a plurality of advertisements that were transmitted during the selected past media event and whose aggregate duration is equal to the calculated duration of the commercial break; and
transmit, to the user equipment device, information corresponding to the identified plurality of advertisements, wherein a display of the identified plurality of advertisements instead of currently transmitted commercials is generated at the user equipment device during the detected commercial break.

46. The system of claim 43, wherein the control circuitry is further configured to:
store a database of previously transmitted advertisements; and
filter information tags corresponding to the stored advertisements for tags that match the selected past media event, wherein the transmitted data comprises information corresponding to a plurality of advertisements each having an information tag that matches the selected past media event.

47. The system of claim 43, wherein the control circuitry is further configured to identify the advertisement based on a user profile.

48. The system of claim 43, wherein the selected past media event is a past live event.

49-54. (canceled)

55. A method for presenting an advertisement, the method comprising:
receiving a first user input selecting a past media event;
receiving a second user input specifying a circumstance under which advertisements transmitted during the past media event should be presented;
transmitting, to a server, a first query for information corresponding to the advertisements transmitted during the selected past media event;
receiving, from the server, data corresponding to the advertisements identified to have been transmitted during the selected past media event; and
generating for display, the identified advertisements when the circumstance specified by the second user input is met.

56. A system for presenting an advertisement, the system comprising control circuitry configured to:
receive a first user input selecting a past media event;
receive a second user input specifying a circumstance under which advertisements transmitted during the past media event should be presented;
transmit, to a server, a first query for information corresponding to the advertisements transmitted during the selected past media event;
receive, from the server, data corresponding to the advertisements identified to have been transmitted during the selected past media event; and
generate for display, the identified advertisement when the circumstance specified by the second user input is met.
